(19) United States
(12) Patent Application Publication
(10) Pub. No.: US 2019/0138575 A1
(43) Pub. Date: May 9, 2019

(54) COUNTERPOINTING SYSTEM

(71) Applicants: John Toba, Pacific Palisades, CA (US); Joshua Creter, North Hollywood, CA (US)

(72) Inventors: John Toba, Pacific Palisades, CA (US); Joshua Creter, North Hollywood, CA (US)

(21) Appl. No.: 16/010,290

(22) Filed: Jun. 15, 2018

Related U.S. Application Data
(60) Provisional application No. 62/520,357, filed on Jun. 15, 2017.

(51) Int. Cl. G06F 17/22; G06N 20/00

(52) U.S. Cl. CPC G06F 17/2235; H04L 67/02; G06N 20/00; G06F 17/2247

(57) ABSTRACT

Embodiments of a system and processes (“counterpointing”) are disclosed to help burst filter bubbles and to break people out of their echo chambers. The system provides “countering perspectives” to users that cause them to consider alternative opinions while also expanding the range of content sources they deem credible. One outcome is an increased self-motivation by users to consume, share or comment on new content sources and items without prompting. The system is designed to integrate into users' daily lives in a variety of ways. It can be accessed by browsing to a social/news feed or publication, executing a search or reading a recap email.

### CROSS-REFERENCE TO RELATED APPLICATIONS

This application claims priority and benefit under 35 U.S.C. 119(e) to U.S. Application Ser. No. 62/520,357, titled “COUNTERPOINTING SYSTEM”, and filed on Jun. 15, 2017, the contents of which are incorporated herein by reference in their entirety.

### BACKGROUND

There is an increasing tendency for people to only consider information that reinforces their beliefs. This confirmation bias can be deliberate, by self-selecting sources of information, or unwittingly, by exposure to social feeds that prioritize personalization and seek to surface content an individual would prefer.

Public awareness of the filter bubble phenomenon is increasing, and the perception that information silos is a problem that has real world consequences. Data shows that the phenomenon of partisanship is real and growing in politics.

Political division is a prominent category of confirmation bias, and the most discussed, but is just one subset of the larger problem. For instance, pop culture and sports debates often involve polarized opinion silos.

While there are many attempts to combat the problem using a combination of balanced news sources, those solutions are all based on an human editorial judgement about what constitutes bias and balance.

### BRIEF SUMMARY

Embodiments of a system and processes (“counterpointing”) are disclosed to help burst filter bubbles and to break people out of their echo chambers. The system provides “countering perspectives” to users that cause them to consider alternative opinions while also expanding the range of content sources they deem credible. One outcome is an increased self-motivation by users to consume, share or comment on new content sources and items without prompting.

The system is designed to integrate into users' daily lives in a variety of ways. It can be accessed by browsing to a social/news feed or publication, executing a search or reading a recap email. When a user views or interacts with a piece of content they can use the system to access other perspectives on the same topic. Even if they do not immediately engage with said other perspectives, the system maps the world of opinion around them to provide counterpoints when they are ready.

With this incremental increase in accessing different perspective, the system fosters a more informed, more self-determining population who are better able to use critical thinking, evaluate multiple perspectives and decide for themselves what they believe.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a simplified system 100 in which a server 104 and a client device 106 are communicatively coupled via a network 102.

FIG. 2 illustrates a communication environment 200 in accordance with one embodiment.

FIG. 3 illustrates a golden slope 300 in accordance with one embodiment.

FIG. 4 illustrates an embodiment of an operating environment 400.

FIG. 5 illustrates additional components of a counterpointing system 208 in accordance with one embodiment.

FIG. 6 illustrates an initialization routine 600 in accordance with one embodiment.

FIG. 7 illustrates a knowledge graph construction process 700 in accordance with one embodiment.

FIG. 8 illustrates an expression pre-processing routine 800 in accordance with one embodiment.

FIG. 9 illustrates an expression analysis process 900 in accordance with one embodiment.

FIG. 10 illustrates an expression communization process 1000 in accordance with one embodiment.

FIG. 11 illustrates an expression selection process for a user 1100 in accordance with one embodiment.

FIG. 12 illustrates a machine learning process 1200 in accordance with one embodiment.

FIG. 13 illustrates a generated user interface 1300 in accordance with one embodiment.

FIG. 14 illustrates a generated user interface 1400 in accordance with one embodiment.

FIG. 15 illustrates a generated user interface 1500 in accordance with one embodiment.

FIG. 16 illustrates a generated user interface 1600 in accordance with one embodiment.

FIG. 17 illustrates a web site 1700 in accordance with one embodiment.

FIG. 18 is an example block diagram of a computing device 1800 that may incorporate embodiments of the present invention.

### DETAILED DESCRIPTION

“Content item” refers to a source of information (e.g. an article or video). “Expression” refers to content items plus social and curatorial activity associated with them (e.g., comments, likes, shares). Content items may reference other content items; content items may summarize longer content items; tweets may in some circumstances be a content item.

Expressions are concrete things (e.g. an article, media clip or social action) that are fixed in time. While someone may attempt to modify an expression (e.g. retracting a quote, clarifying an opinion, fix a typo), from the system's perspective the original expression remains unchanged and subsequent action creates a new expression.

Each expression comprises one or more sentiments (e.g. agreement, skepticism, rejection, revulsion). Each expression also comprises one or more topics. Collectively, an expression, its topic(s) and sentiment(s) are a “viewpoint”.

Some expressions are not directly about a topic. Instead they are about another expression (e.g. a like, a comment or a commentary). Expressions may nest indefinitely but still collapse down to a single viewpoint (e.g. liking a comment that disagrees with a commentary analyzing an opinion piece). Expressions may also introduce additional topics (e.g. a comment on an opinion piece about [Team X] that adds a comparison to [Team Y]).

A collection of viewpoints held by a person build up a “perspective”. While viewpoints are fixed in time (because they are built upon expressions), perspectives can and do evolve. The system takes this into account by weighting analysis over time.

The system focuses on a user's current perspectives, and reduces the influence of previous expressions when calculating new expressions to present. However there may be significant enough shifts in a user's perspective that multiple distinct viewpoints are apparent. In those cases, the system may present expressions from different viewpoints (though would tend to note historical versus contemporary views).

Notation

Basic Viewpoint Definition:

Expression+Sentiment+Topic=Viewpoint

Viewpoints about Viewpoints (Compressed and Expanded Notation):

Expression+Sentiment+Viewpoint=Viewpoint

Expression+Sentiment+(Expression+Sentiment+Topic)=Viewpoint

Adding a Topic:

Expression+Sentiment+Topic+(Viewpoint)=Viewpoint

Perspective Definition:

Viewpoint+Viewpoint+[additional Viewpoints . . . ]=Perspective

All expressions utilized by the system are about subjects that can be uniquely identified. When expressions are self-referential (e.g. “I am happy”) or highly opaque (e.g. “Is it 29 ?” the system determines that those expressions have little utility.

Determining an expression's subject may require analyzing expressions that it refers to (e.g. “This is wrong”; liking a post). In these cases, expressions may introduce additional topics (e.g. “This is wrong and also war is bad”).

The specific subjects of expressions are “topics”. These may be people, places, things, actions and/or ideas (i.e. proper and general nouns). In general, topics are explicitly mentioned in the expression (usually in the section we identify as containing the topic).

Topics are combined into categories called “domains”. Unlike topics, domains may or may not be explicitly present in the expression (e.g. “Sports”, “US Politics”). The system primarily determines domains by mapping topics into them (e.g. names of teams into “Sports”) along with hints based on the content source (e.g. a sports-oriented publisher).

When choosing to present expressions for countering perspectives, the system may choose expressions about a different topic. For example for the expression “[Football team X] is great” the system may present “[Football team X] is terrible”, “[Football team Y] is the best” and/or “Football is boring, basketball is the best”. However, the system does not present expressions from different domains (e.g. all expressions are from the “Sports” domain).

While most expressions fall into a single domain, some cross into multiple domains. In these cases, the system attempts to determine a primary domain. It also attempts to present expressions that also come from the same set of domains, but possibly for different topics.

People in the system's knowledge graph are referred to as “actors”. This includes creators of expressions (i.e. authors), users of the system, subjects of topics the system follows, and social account holders (e.g. content curators the system tracks; users of other systems that expressions reference). People may occupy multiple roles in the modern media landscape. The division between subject, commentator and audience has increasingly become blurred.

Some preference (higher relevance) may be given by the system to actions performed by users of the system to influence the growth of the knowledge graph.

“Publisher” refers to organizations where content is created and distributed (e.g. websites and media outlets). When an expression is published by a publisher it likely goes through an editorial process that harmonizes it with an overall perspective held by the organization. Expressions by different authors from the same publisher likely have similar qualities (structural and perspective).

These similarities can range from editing style and language choices to explicitly stated beliefs or deliberate attempts at neutrality. While some publishers have a stronger editorial hand than others, it is important to include these overall bents in the system's analysis, because expressions by different authors from the same publisher are likely to have similarities.

This is a signal similar to community affiliation (see below) to help determine similar and countering perspectives. The system explicitly excludes self-publishing outlets (e.g. social media, personal websites) from “publishers”, are those expressions most purely reflect viewpoints of their authors (e.g. “all opinions here are my own”).

The system considers publisher's official accounts on those platforms to be extensions of the publisher (e.g. @NYTimes, nytimes.com and The New York Times print edition are equivalent). The system treats publisher's “voices” (e.g. editorial boards and ombudsman) as distinct actors that happen to be published by the publisher.

Applying automated cluster analysis techniques, the system groups actors and publishers into communities. This is performed based on a degree of cross-referenced expressions and commonly held perspectives. These are communities as determined by the system and not self-identified by actors or publishers.

The system assumes that all users have some affinity with one or more communities, even if it has yet to identify them. Individuals create unique thoughts and expressions, but those perspectives do not exist in a vacuum. Even emerging perspectives are based on (or are in reaction to) existing communities of thought. The system thus estimates if users have awareness of or agreement with expressions that we have not directly observed.

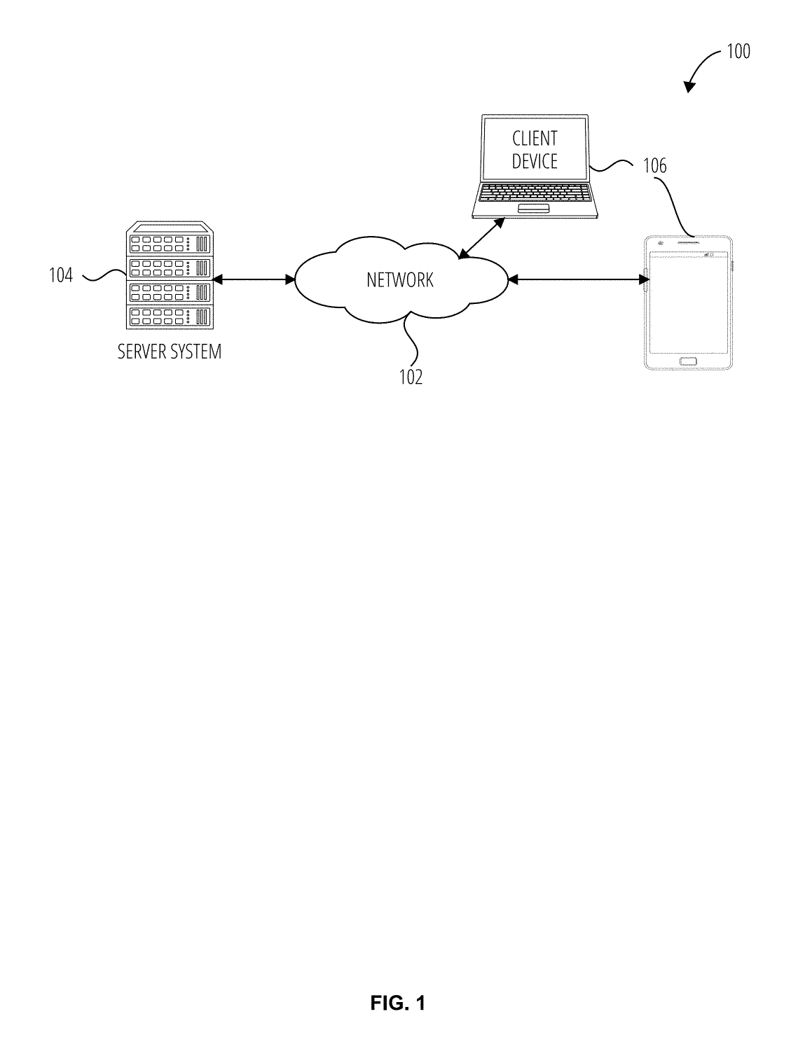

FIG. 1 illustrates a system 100 in which a server 104 and a client device 106 are connected to a network 102. In various embodiments, the network 102 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like. In some embodiments, the network 102 may also include a voice network that conveys not only voice communications, but also non-voice data such as Short Message Service (“SMS”) messages, as well as data communicated via various cellular data communication protocols, and the like.

In various embodiments, the client device 106 may include desktop PCs, mobile phones, laptops, tablets, wearable computers, or other computing devices that are capable of connecting to the network 102 and communicating with the server 104, such as described herein.

In various embodiments, additional infrastructure (e.g., short message service centers, cell sites, routers, gateways, firewalls, and the like), as well as additional devices may be present. Further, in some embodiments, the functions described as being provided by some or all of the server 104 and the client device 106 may be implemented via various combinations of physical and/or logical devices. However, it is not necessary to show such infrastructure and implementation details in FIG. 1 to describe an illustrative embodiment.

The systems and methods disclosed herein are designed to operate in a network environment such as the system 100. Aspects of the invention may operate on one or more server 104, a client device 106, or a combination of both.

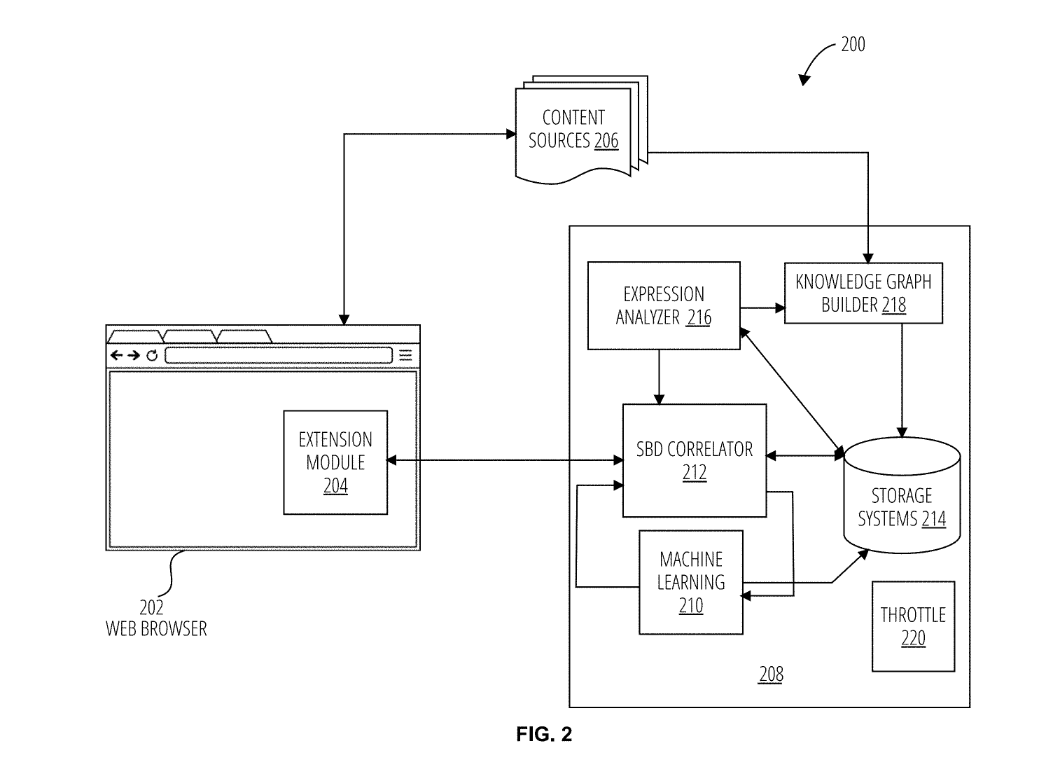

FIG. 2 illustrates an example communication environment 200 for operating a counterpointing system 208 that utilizes feedback loops and algorithms to generate a specific user interface coupled with proscribed functionality to enable users to incorporate multiple perspectives into their digital content consumption experience. The counterpointing system 208 includes feedback loops to reconfigure based on use (to “learn”). The counterpointing system 208 provides a user interface for much more efficient location and navigation of expressions that drive a user's perspective up the so-called Golden Slope.

In one embodiment the web browser 202 is implemented in a web browser 202 having an integrated extension module 204 for accessing content sources 206 and engaging the counterpointing system 208. The counterpointing system 208 utilizes machine learning logic 210 and a similar-but-different (SBD) correlator 212. The counterpointing system 208 also utilizes storage systems 214 for saving learned information about users, accessing learning models, etc.

The counterpointing system 208 bears some general similarities with content recommendation engines, but significantly differs in a number of ways. For example, it offers “similar but different” rather than “more of the same”. This requires a fundamentally different logical model of the content landscape and how people process opinions and recommendations, resulting in a decidedly unique solution.

For example, counterintuitively to conventional content recommendation systems, rather than incorporate a large amount of initial knowledge into its memory and model, the counterpointing system 208 is deliberately initialized in a naive state, a technique referred to herein as a “limited knowledge” approach.

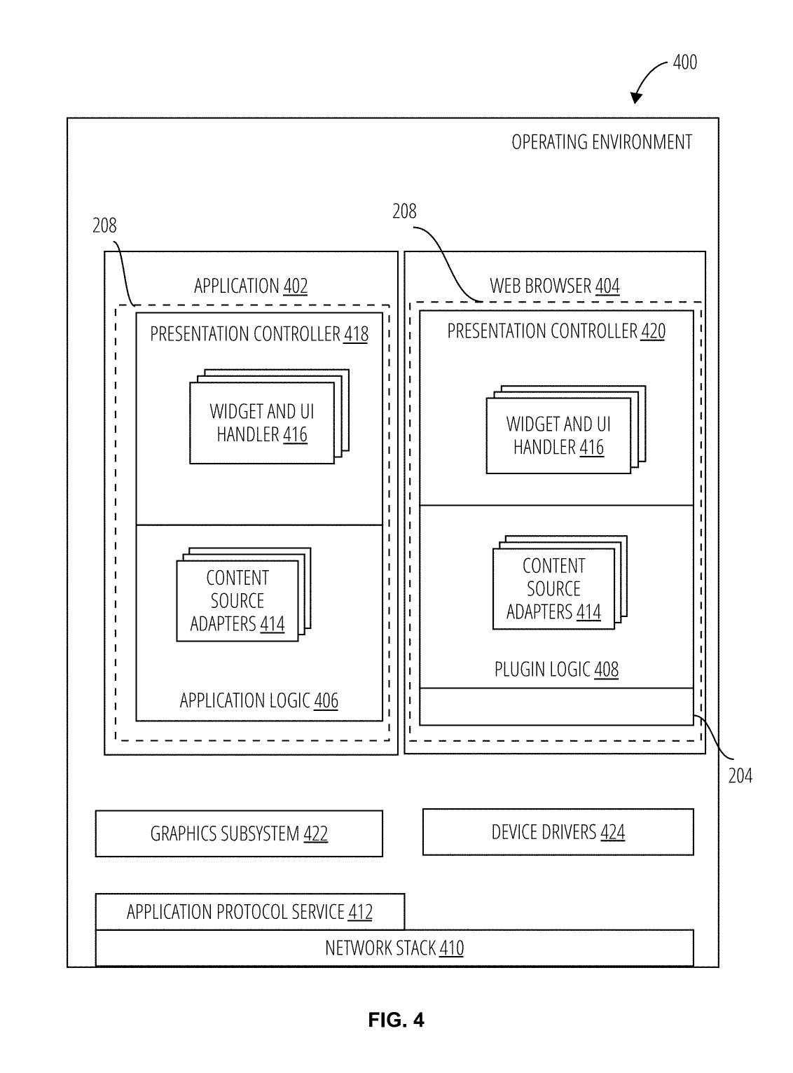

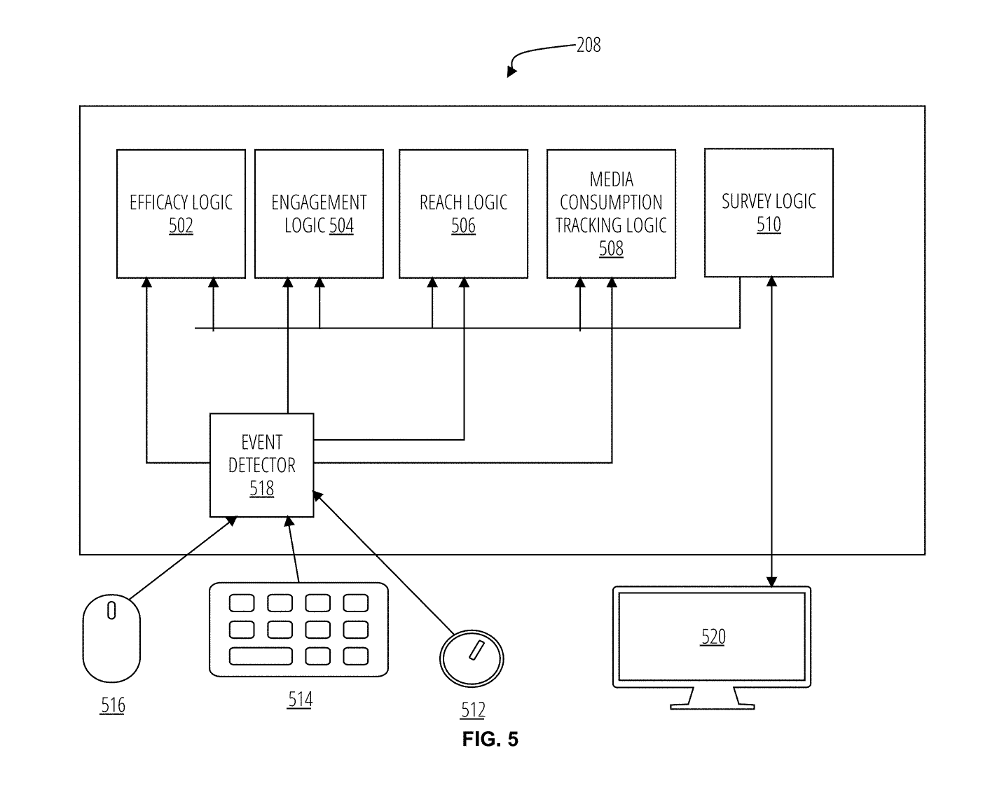

The counterpointing system 208 may further comprise a throttle 220, a knowledge graph builder 218 and an expression analyzer 216, the functions of which are explained further on. Other features of the counterpointing system 208 are illustrated and discussed in conjunction with FIG. 4 and FIG. 5.

One embodiment of the counterpointing system 208 utilizes a combination of web and machine learning technologies. For example:
JavaScript and NodeJS for internal and web-facing computation.
Python, TensorFlow and Keras for machine learning.
Chrome Extensions for browser extensions.
RSS and Scrapy for content feeds.

In some implementations, the computation engines (algorithms) are primarily cloud based (both CPUs and GPUs). For data storage, the system may use a mix of storage technologies:
GraphQL—Knowledge graph.
SQL—Transactional data and logs.
NoSQL—Expressions and other unstructured data.
Blob—Expression screenshots.
Embodiments of the system may use several third-party service providers:
Email (e.g. Sendgrid) for sending recap emails to users.
Natural Language Processing (e.g. Watson) for sentiment analysis.
Entity ID (e.g. Google Knowledge Graph) for topic normalization.
Analytics (e.g. Google Analytics) for user behavior tracking.
OAuth Providers (e.g. Facebook, Google) for user identification.

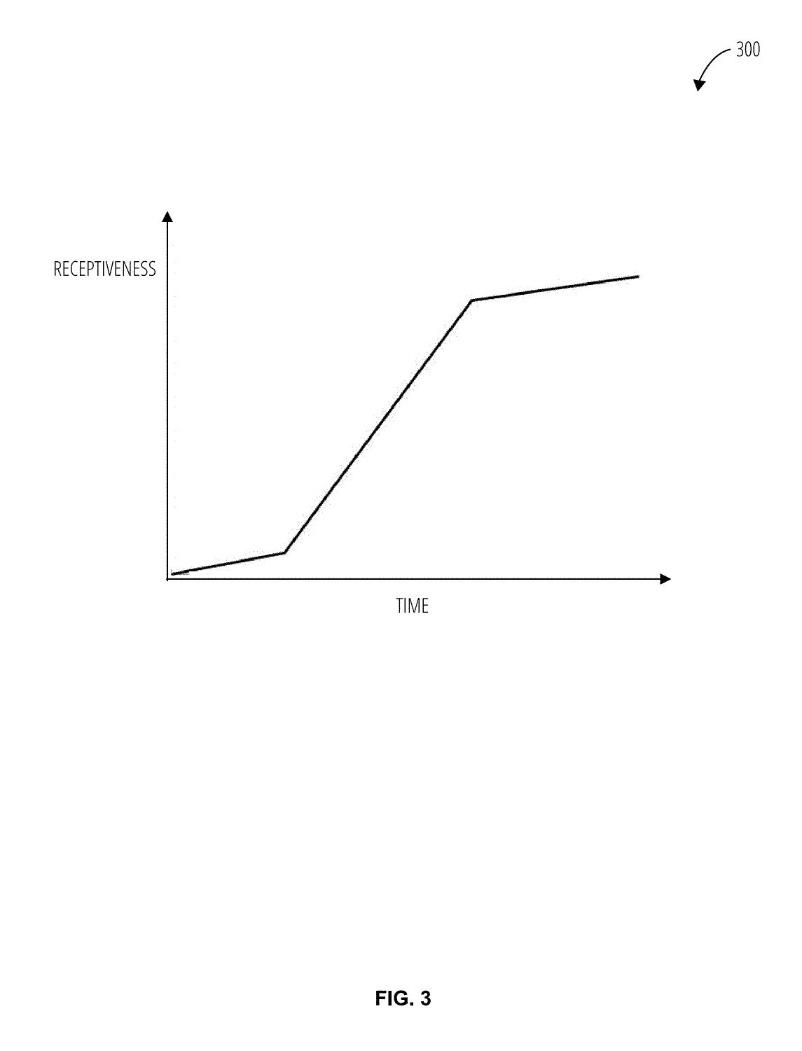

The system seeks to increase an openness to new sources of opinions and a willingness to incorporate these countering perspectives into a user's world view. FIG. 3 illustrates a golden slope 300 behavior model that approximates the desired results.

Many users are on the bottom left of the slope: comfortable with a set of views and familiar sources of opinions. On the top right is the idealized user: thinking critically, open to all sources of opinion, able to judge them independently and actively seeking new perspectives.

In the middle are users who are open to new perspectives if they are led to them and people who are acclimating to unfamiliar viewpoints. This is where the system may operate most effectively, with users open to new perspectives.

Getting to the middle of the slope takes time and effort, as reflected by the first inflection point on the graph. Some users (especially initial users) may already be past this point if they come seeking out alternative sources of opinions. Moving up the slope initially is difficult but gets easier over time.

Ultimately there is likely some degree of efficacy falloff as users are exposed to the bulk of commonly held perspectives. For all but the most dedicated thinkers, there are some perspectives that are too inscrutable, far-fetched or abhorrent to consider. This is represented by the second inflection point.

The system does not seek to “convert” people or change any of their specific beliefs. Rather the aim is to increase people's willingness to consider new perspectives. It is sometimes enough for people to recognize that they live in a world of multiple perspectives without interacting with them. This influences the system's overall approach and design (i.e. unlike traffic generator schemes, which attempt to goad people into clicking on or interacting at every available opportunity).

FIG. 4 illustrates an operating environment 400 illustrating two modes of implementing client-side logic for the counterpointing system 208.

One embodiment of the counterpointing system 208 is implemented using an extension module 204 in a web browser 404. Another embodiment is implemented as an application 402 for a mobile phone or computer system (e.g., laptop, tablet, desktop etc.). In a similar embodiment, the application 402, counterpointing system 208, or portions thereof may be implemented on a server system (e.g., server 104).

The implementations utilize content source adapters 414 and a widget and UI handler 416 for generating the structured user interface with proscribed functionality to enable more efficient counterpointing communications. The presentation controller 420 for the web browser 404 implements these features using browser plugin logic 408, whereas the presentation controller 418 of the application 402 implements these features using application logic 406.

The implementations are built on similar underlying subsystems, for example a graphics subsystem 422, device drivers 424, an application protocol service 412, and a network stack 410.

In a preferred mode the presentation controllers generate widgets that are injected onto the user's view of the content expressions (e.g., onto web pages). The widgets may resemble existing popular designs to remain familiar to users. The widgets may optionally (based on user preference) replace other 3rd party content recommendation widgets (which are often intended to drive traffic to unrelated properties).

To support widget injection and user content consumption analysis, the system in one embodiment uses the browser extension module 204. While this approach allows for the greatest flexibility in customizing user experiences, it has some drawbacks (e.g. general challenges browser extensions face with user adoption; varying support for extensions by browser manufacturers). Other options are the application 402 implementation and server-side incorporation of the counterpointing system 208 logic by publishers and others.

FIG. 5 illustrates additional components of the counterpointing system 208. The counterpointing system 208 may further comprises efficacy logic 502, engagement logic 504, reach logic 506, media consumption tracking logic 508, and a survey logic 510. These various components interact with devices such as a timer 512, a keyboard 514, a mouse 516, and a display 520. User events are detected by the event detector 518 and input to the relevant components for processing. Various of the components may also input from the survey logic 510.

Efficacy Logic

The efficacy logic 502 determines, through approximation, how far someone has traveled up the Golden Slope, or if they've backslid. The counterpointing system 208 uses a combination of measures, some known in the art and some described further below, to determine if individuals are expanding the sources and ranges of perspectives they consume. These include direct interactions with the system, general media consumption behavior and targeted surveys. Efficacy is typically the most highly weighted indicator.

Engagement Logic

The engagement logic 504 measures and tracks how much people are using the system. Importantly, use of the system should ideally become part of users' regular routines. The counterpointing system 208 seeks to maximize the quality of interactions (i.e. enjoyment, utility and efficacy as determined by users) rather than their frequency, quantity or length.

The system uses standard web product metrics to measure how people are using the system. These include:
Daily/weekly/monthly active/unique/repeat/new users.
Interactions per system interface (e.g. injected widgets, direct access, recap email).
Click paths (i.e. are people accomplishing our pre-defined interaction goals or getting lost in the interface?)

Reach Logic

The reach logic 506 determines how much of an impact the counterpointing system 208 is having overall. The counterpointing system 208 uses a combination of unique (new) users and external references to the system (e.g. organic media mentions).

The reach logic 506 engages in social and traditional media monitoring to measure how people are organically talking about the system. It also may ask similar questions as part of targeted user surveys (e.g. “Have you told anyone about our system?”). The system also tracks referrals from the system by users (e.g. “send to a friend”).

Media Consumption

The media consumption tracking logic 508 engages in standard web tracking to determine how people interact with web-based content. It tracks both how people engage with content that the system presents to them and (where possible) content that they arrive at themselves (e.g. tracking enabled by our browser extension).

Some metrics the media consumption tracking logic 508 may track include:
Content notices—for content the system displays (e.g. a summary), did the person scroll it into view long enough to notice?
Content views—did the person view a piece of content at all?
Content engagements—did the person interact with the content in a way that indicates they did more than just skim it (e.g. significant time spent, scrolling to end, scrolling back to re-read sections).
Content bounces—conversely, did the person interact with the content in a way that indicates active revulsion (e.g. scrolling past summary, quickly clicking back, sending negative feedback to us).
Content social actions—did the person share, like or comment upon a piece of content?
Direct publisher accesses—did the person directly access a content source (either via direct domain or web search)?

The counterpointing system 208 does not seek to change behavior regarding creating, sharing or commenting upon opinions or topics. While the system may observe a corollary effect (e.g. engaged readers may tend to become sharers or content creators), it is not something it seeks either to drive or discourage.

Targeted Surveys

For active users, the survey logic 510 generates surveys to gain information about media consumption it cannot directly measure. It does this on a “past several days” to “past week” timescale. These are presented as questions inside the counterpointing system 208 (e.g. pop-ups generated via the system's web browser extension) or as direct messaged links to web-based surveys. Types of questions the survey logic 510 may ask include:
Have you seen [topic]?
If so, how much? Which sentiments were expressed?
In what formats (online, print, broadcast)?
Did you agree with these perspectives?
Have you viewed [publisher]?
If so, how much? Have you viewed them before?
What topics did you see there?
Did you agree with these perspectives?
What do you think of [sample perspective]?
Do you understand it?
Do you agree with it? If not, do you appreciate their argument?

Human Review

While the counterpointing system 208 relies primarily on analysis of user actions for system training feedback, it also incorporates several human oversight mechanisms. These people exist outside the bounds of typical users and have access to specialized interfaces.

Editorial Review

This group consists of experts with backgrounds as editors and curators for existing publications and media outlets. Their primary responsibility is to review the overall sources of expressions entering our system to ensure that they represent a balanced range of publications, authors and viewpoints. This oversight is critical to avoid unintentional biases (either actual or perceived)—especially during the initial phases of the “limited knowledge” approach.

They also are tasked with providing feedback about the system's topic analysis methodology. Any categorization of factual information may require human judgement (e.g. terminology for disputed regions of the world).

Analysis Review

This group consists of experts with backgrounds in machine learning and natural language processing. Their primary responsibility is to review the internals of our system's core algorithms and the data generated by them. Even well-understood systems and techniques may produce unexpected results (e.g. unintentional overtraining of the learning feedback loop) and thus rely on this type of review to help analyze and validate the system. Additionally this group provides insights into advances in this rapidly evolving space.

Quality Review

This group consists of experts with backgrounds in quality analysis and systems review. Their primary responsibility is to validate the testing approaches used on the system. Specifically, they provide feedback on both the scope of what is tested and methods used. They can help identify blind spots and unintentional confirmation biases—especially for aspects of the system with few established best practices for quality control or testing (e.g. analyzing complex human behaviors in relationship to the Golden Slope model).

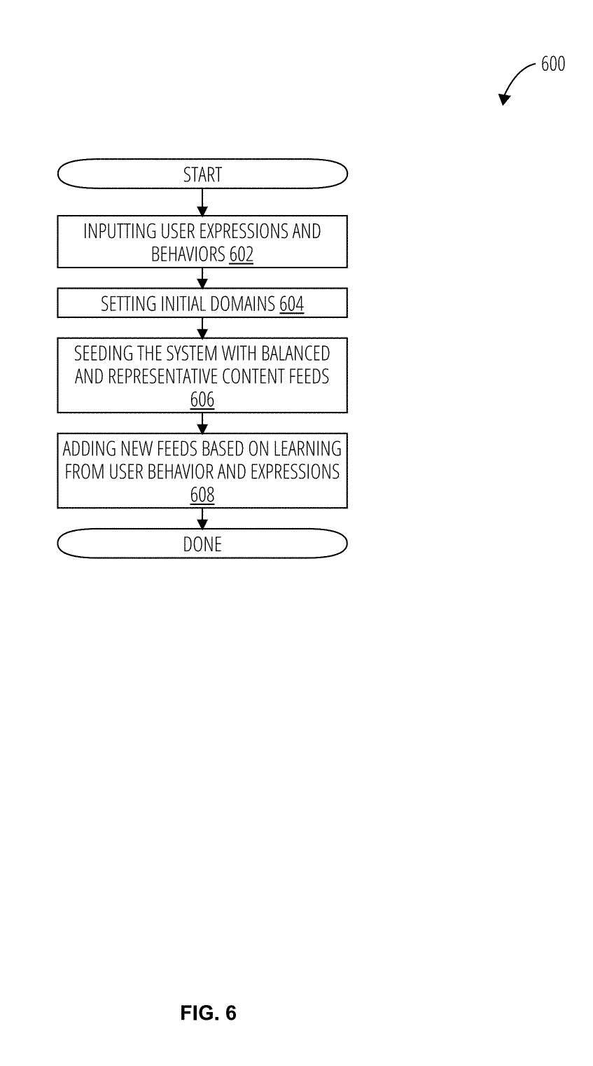

FIG. 6 illustrates a knowledge graph initialization routine 600 in accordance with one embodiment.

The counterpointing system 208 may utilize three primary algorithms during operation. The first algorithm maps out a universe of expressions (e.g., a knowledge graph builder 218). The first algorithm is utilized for discovery and prioritizing of expressions. To this end it utilizes both intrinsic analysis of the expressions, and generates a graph representing their relationships (extrinsic analysis).

The first algorithm may utilize the following inputs:
User content consumption (e.g. viewing expressions)
User behaviors (e.g. sharing, liking, commenting on expressions)
Relevant content feeds (including publishers and key social media curators)
Limited following of linked expressions (i.e. spidering)

The first algorithm is seeded with a balanced, yet representative, set of content feeds for an initial set of domains. The algorithm learns and expands the knowledge graph primarily from the feed of expressions generated by the content consumption of users, and automatically adds new actor and publisher feeds. This occurs when users routinely consume expressions from an actor or publisher. Unlike the initial set of seeds, these additional feeds are determined algorithmically.

The initialization routine 600 thus begins by inputting user expressions and behaviors 602, which are applied for setting initial domains 604. The initialization routine 600 proceeds seeding the system with balanced and representative content feeds 606, and adding new feeds based on learning from user behavior and expressions 608.

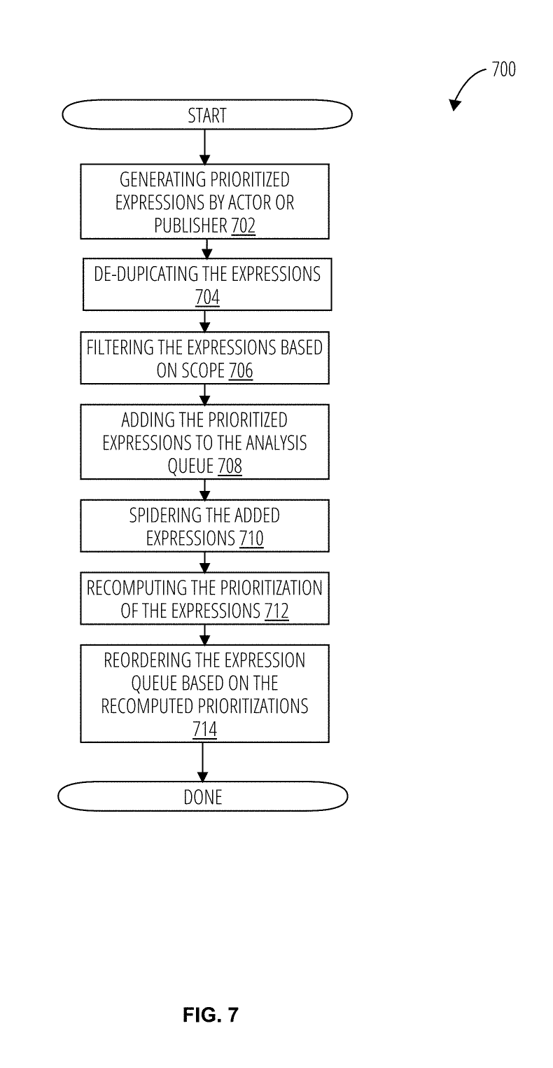

FIG. 7 illustrates a knowledge graph construction process 700. The counterpointing system 208 generates a list of expressions by the actor or publisher (giving preference to their most recent and/or most important expressions) and then adds them to the analysis queue. This may include adding previously published expressions as well as monitoring for new ones. In keeping with a “limited knowledge” approach, this helps fill critical gaps in the system's knowledge graph (i.e. adding expressions without waiting for users to discover them).

Following FIG. 7, the knowledge graph construction process 700 begins by generating prioritized expressions by actor or publisher 702, followed by de-duplicating the expressions 704. This is followed by filtering the expressions based on scope 706 and adding the prioritized expressions to the analysis queue 708. With this initial set of expressions in hand, the next steps are spidering the added expressions 710, recomputing the prioritization of the expressions 712, and reordering the expression queue based on the recomputed prioritizations 714. Particular ones of these actions are described below in more detail.

The counterpointing system 208 follows references (e.g. web links and citations) from one reference to another. This is referred to as “spidering”. As part of this process, the system detects and avoids black holes and loops by limiting the depth at which it will follow references.

Given the potential to overwhelm system resources, some sort of queuing and/or prioritization is necessary. Expressions are added to the processing queue based on the order in which the system becomes aware of them (e.g. user activity and automated feeds). However, the queue is constantly reordered based on an importance metric with the following elements:
Timeliness—how recently was the expression created (possibly different than when the system became aware of it)?
Reach—how big of an audience does it and/or its creator have?
Reference Count—how many other expressions overall reference it?
User Boost—activity by users relating to the expression (e.g. a user currently viewing the expression)?

To avoid repeated work, expressions are deduplicated prior to adding them to the queue. The counterpointing system 208 attempts to find the canonical identifier for the expression (e.g. unshortened URL stripped of 3rd party tracking data) and then scans through the queue and list of previously processed expressions. If a match is found for an unprocessed expression, it may then be boosted higher in the queue so it is processed sooner.

Additionally the stream is filtered for overall applicability based on initial scopes (e.g. US-centric politics and pop culture). Even as scopes are expanded, certain content may be of little use to the system and should be excluded (e.g. purely factual items like weather or sports scores; prurient items).

A throttle 220 component (see FIG. 2) provides signals to the other components of the counterpointing system 208 to control when to increase or decrease analysis resources (i.e. how deep the queue is and how high a priority each unprocessed expression has been given).

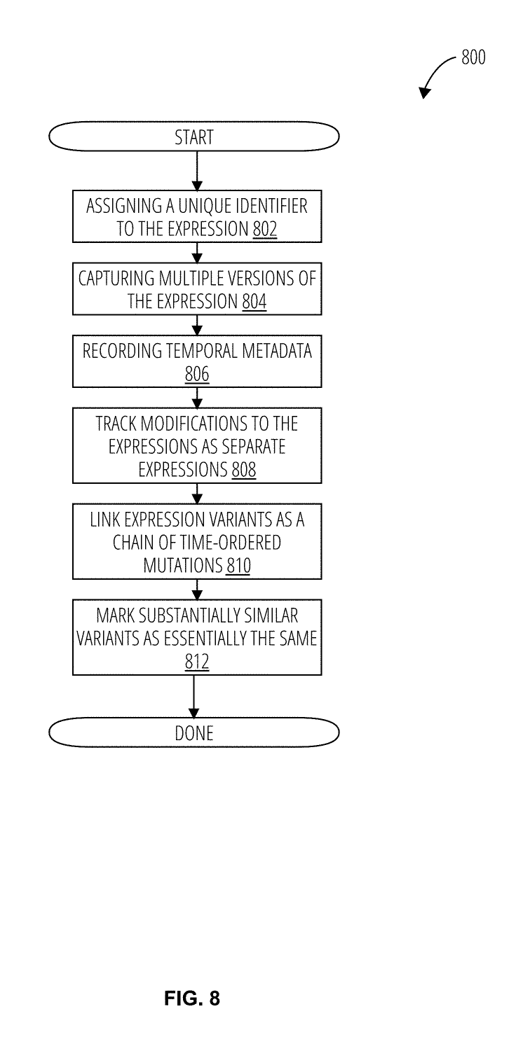

FIG. 8 illustrates aspects of an expression pre-processing routine 800 in accordance with one embodiment. The expression pre-processing routine 800 begins with some preliminary actions, such as assigning a unique identifier to the expression 802 and capturing multiple versions of the expression 804. This preprocessing may include recording temporal metadata 806 as well.

To account for variants of the same basic expression (e.g., versions, updates), the expression pre-processing routine 800 may track modifications to the expressions as separate expressions 808, link expression variants as a chain of time-ordered mutations 810, and mark substantially similar variants as essentially the same 812. Particular ones of these actions are described in more detail below.

Thus before performing the actual expression analysis, the counterpointing system 208 performs a number of preliminary steps. An expression is first assigned a unique identifier. The system records if the expression has its own identifiers (e.g. URL, DOI, ISBN) but does not rely upon them. For instance, expressions may not have identifiers (e.g. the result of a social sharing action; an arbitrary piece of text; a direct message) or they may be non-canonical (e.g. a manually copied fragment or screenshot).

The counterpointing system 208 captures multiple versions of the expression (renditions). Where possible, the counterpointing system 208 algorithms extract and identify the expression's core content including metadata (e.g. via an API). While this provides for cleaner access to the content by avoiding issues associated with web scraping, it may lose some context. Therefore, the counterpointing system 208 attempts to capture the entire expression as it appears to the user. For a long form content item (e.g. an article), this may involve archiving an entire web page including surrounding material (e.g. images, style data, comments, UI elements, related content). Finally, the counterpointing system 208 may also capture a rendered view of the expression (e.g. a screenshot).

Using multiple capture techniques allows both a better approximation of how humans experience the expression (e.g. headline size, pull quotes, image placement) and improved content extraction for later analysis (especially when clean API access is unavailable).

The counterpointing system 208 records in the storage systems 214 several pieces of temporal metadata:
When a reference to the expression entered the system. The reference to an expression may be recorded prior to actual processing of the expression.
If known, when the expression was created or published (this is extracted from the expression itself).
A log of processing actions taken on the expression by the system.
A log of when and why the expression was entered into the system (e.g. in response to user activity vs automated feed expansion).

Expressions are treated as immutable (i.e. unchanging once published). But because expressions themselves may be updated (e.g. revisions to an article) or even deleted, the system tracks modifications as separate expressions. These variants are linked as a chain of time-ordered mutations (based on extracted publication date) so as to aggregate them for analysis.

Most variants do not significantly alter the substance of expressions (e.g. typo corrections; clarifications; additional details). Such variants are treated as essentially the same. However, some modifications do radically impact the nature of an expression. In some cases, the modifications to a piece of content radically alter it, such that it becomes necessary to determine which revision subsequent expressions were referring to in order to understand them.

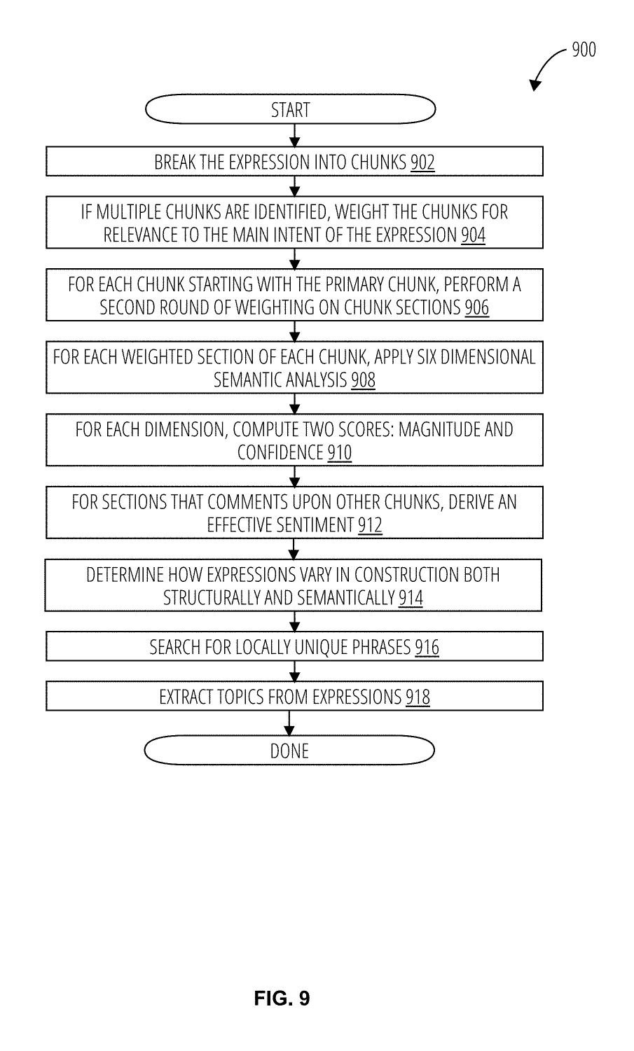

FIG. 9 illustrates aspects of an expression analysis process 900 in accordance with one embodiment. The counterpointing system 208 may first break the expression into chunks 902. Then the system may, if multiple chunks are identified, weight the chunks for relevance to the main intent of the expression 904. The system may then, for each chunk starting with the primary chunk, perform a second round of weighting on chunk sections 906, and for each weighted section of each chunk, apply six-dimensional semantic analysis 908, and for each dimension, compute two scores: magnitude and confidence 910, and for sections that comments upon other chunks, derive an effective sentiment 912.

The system may then determine how expressions vary in construction both structurally and semantically 914, search for locally unique phrases 916, and extract topics from expressions 918. Particular ones of these actions are described in further detail below.

When analyzing an expression (i.e. a piece of content or social/curatorial action), the counterpointing system 208 employs two types of analysis: intrinsic and extrinsic. Intrinsic analysis is analysis of the content itself—what topics is it about, what sentiments does it convey and what is its format (e.g. language complexity). Extrinsic analysis analyzes how the expression fits into the larger universe—who created it and how does it connect to the rest of the graph (e.g. referencing and social actions). The two types of analysis (and their results) are significantly different.

Intrinsic analysis involves understanding the purpose and meaning of an expression. Existing semantic and content analysis techniques and APIs are utilized to distill pertinent information. Prior to that analysis the system performs preliminary steps to help understand the expression's structure.

The counterpointing system 208 first breaks the expression into logical units (“chunks”). While some expressions are a single chunk (e.g. a simple tweet), others are composed of multiple chunks (e.g. a piece with extensive block quotes; a highly structured scholarly article; a disjointed ramble). Different chunks may have widely varying intents and meaning. For instance, one chunk might contain background information or an interesting anecdote while others might form the central argument of the piece.

This is an imprecise process, both because of the current limitations of automated processing and the variations of human speech/writing. Some speakers/authors are notorious for smashing disconnected ideas together into a single expression while others are famed for carefully constructed logic and rhetoric.

One type of chunk that is identifiable with higher confidence are is quotes (both inline and block), mostly because there usually are linguistic and typographic hints to set them apart for human readers.

The counterpointing system 208 assumes that most chunks are delineated using standard editing conventions (e.g. section headings, paragraph breaks, lists and parentheticals) and stock phrases (e.g. “there once was”), though there will always be expressions that break these rules.

The counterpointing system 208 may be configured to operate as follows:
Most short (˜50 words or 200 characters) expressions are a single chunk.
Most medium length (˜400-1000 words) expressions are a single chunk.
Most longer expressions contain multiple chunks.
Most presentations contain multiple chunks.

In the event multiple chunks are found, the counterpointing system 208 weights the chunks for relevance to the main intent of the expression. The system separates out quotes (since they are other expressions) and reduces weighting for asides. The system assumes that the remaining chunks coalesce into a single “primary chunk” that forms the main expression. The goal of this process is to reduce noise for later semantic analysis. It does not need to be perfect, and so tends to err on the side of including information (i.e. not reducing weighting) rather than excluding it.

For each chunk (starting with the primary chunk), the counterpointing system 208 performs a second round of weighting. The system identifies sections of the expression pertaining to its topic(s), argument(s), supporting points, commentary on other chunks (e.g. quotes or referenced expressions). Most opinion-based content/primary chunks may follow a similar pattern (the “inverted pyramid”):
Headline
Subhead
Introduction
A single topic
A single argument
Supporting points
Restatement of argument
Conclusion

Most asides and quotes are treated as simpler:
A single argument
OR a single argument and supporting points
OR only supporting points

Certain words are treated as more strongly associated with different sections (e.g. “should” and “must” for arguments, “for instance” for supporting points). Topics are treated as likely being unique words (either proper names or specific nouns), likely identified prior to analysis. The goal of this analysis is to identify the key parts of the expression for later analysis (i.e. arguments rather than supports).

For each weighted section of each chunk, the counterpointing system 208 applies semantic analysis, using the following six dimensions:
Overall strength of the sentiment, i.e. how strongly worded is the sentiment.
Positive-negative axis—how much like or dislike is contained in the sentiment, e.g. “love”, “hate”.
Agreement-disagreement axis. Is the sentiment supporting or countering (e.g. a topic, supporting point or other chunk), e.g. “right”, “wrong”.
Humor-seriousness axis, i.e. is the sentiment attempting to express humor, e.g. “kidding”, “gravely”. This is a weak axis.
“Truthiness” axis. Is the sentiment saying something is true or false (e.g. a topic or other chunk), e.g. “correct”, “this is a lie”.
Importance axis (either overall or to the expression itself), e.g. “important”, “key”, “irrelevant”.

For each dimension, the counterpointing system 208 computes two scores: magnitude and confidence.

For sections that comments upon other chunks (e.g. a quote), the counterpointing system 208 may derive an “effective sentiment”. This is done by applying the section's scores to the chunk's scores. For instance, if the quote expresses a negative sentiment about its topic but the section itself expresses a negative sentiment about the quote, the section's effective sentiment about the topic would be positive.

The resolution of the analysis performed varies among three types of objects: sentences, sections, and chunks. The different resolutions balance between detailed and overall comprehension. Some analysis techniques perform differently/better at different resolutions. Sentiment analyses are combined with the section weightings to distill a set of overall sentiment(s) about topic(s) contained in the expression.

Additional forms of linguistic analysis are also applied to expressions. The counterpointing system 208 attempts to determine how expressions vary in construction (both structurally and semantically). For instance:
A strong sentiment followed by neutral supporting points.
A series of strong sentiments.
A classic inverted pyramid.
A sequence of alternating, opposing sentiments.

Users may be accustomed to certain styles of expressions and argumentation. This analysis enables the system to search for expressions with similar construction patterns but varying specific sentiments.

The counterpointing system 208 performs two types of linguistic measures:
Vocabulary complexity—the types of words used (word length plus obscurity).
Reading level—vocabulary complexity plus sentence length.

This analysis enables the system to find expressions of similar complexity when searching for countering perspectives (i.e. to enable the user to focus on the content of the expression without being jarred by the format of it).

The counterpointing system 208 searches for “locally unique phrases”, a list of phrases that do not occur in a broad corpus but do appear in subsets (e.g. “law and order”, “welfare state”, “right wing”). The system automatically grows this list over time. The system does not assign meaning to the phrases in this list, but only observes their usage.

The counterpointing system 208 extracts topics from expressions using a combination of metadata analysis (where available), naive keyword matching, and existing machine learning toolkits. The system applies knowledge gained from expression analysis, e.g. that an expression referring to another expression likely pertains to the same topic.

To aid the analysis, the counterpointing system 208 gives preference to content identified as important during the initial intrinsic analysis phase (e.g. headlines and primary arguments). This is in keeping with the classic “inverted pyramid” structure most news and opinion-based content follows.

Depending upon the techniques used, the counterpointing system 208 may also generate a confidence score for either the strength or accuracy of the topics and identify hints about primary versus secondary topics for an expression (e.g. explicitly noted in existing metadata).

Once raw topic keywords have been extracted, they are normalized and de-duplicated. This is accomplished using an external entity database for people and places (e.g. Google Knowledge Graph Entities) combined with simple stemming and synonyms replacement for general concepts and things.

The counterpointing system 208 determines domains through a combination of topic mapping (initially manual, in some cases) and content metadata (when available). The system also applies hints based on publication and actor (i.e. most tend to publish in one domain).

One initial approach is to generate a simple “bag of nouns”. For example the counterpointing system 208 might extract “human rights” and “[country]” rather than “human rights in [country]” or “recent advances for human rights in [country]”. The system does not extract verbs or qualifiers. For example it may extract “[actor]” and “[actor]” rather than “[actor] threatens [actor]” or “[actor] and [actor] announce pact”.

Due to a focus on contemporary perspectives about contemporary topics, the counterpointing system 208 will typically not determine if a topic is about a historical event unless that information is explicit (e.g. “In 1983 the nation was at a crossroads . . . ”). However, it does track when expressions were created, and utilizes that information. Therefore, the system will assume that discussions of “conflicts” and “leaders” tend to refer to events and people that existed at the time the expression was created. This means the system may do poorly with highly contextual historical analysis. For instance, it may interpret a contemporary piece that states “the Prime Minister was wrong” without referring the person by name or date to be about the current leader rather than a predecessor, as intended.

While simplistic, this approach is sufficient given the other signals the system uses. If more complex topic extraction is required, the system may be augmented without significant impact to the design.

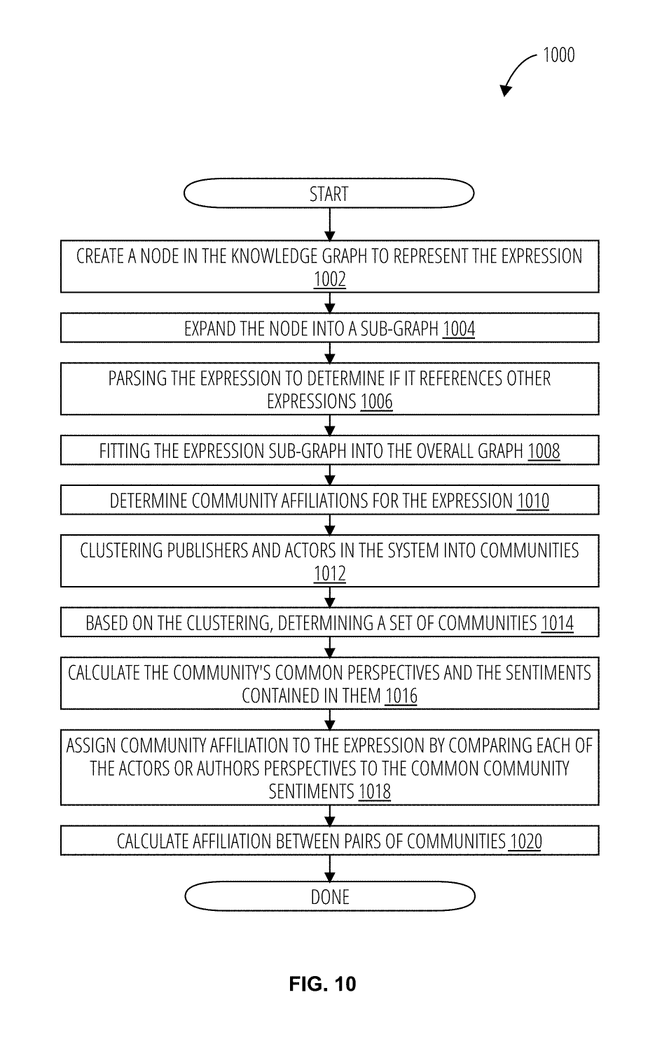

Referring now to FIG. 10, extrinsic analysis involves fitting expressions into the system's knowledge graph. The knowledge graph is a data structure that records the relations (edges) among expressions (nodes). FIG. 10 illustrates one embodiment of an expression communization process 1000.

The counterpointing system 208 may create a node in the knowledge graph to represent the expression 1002 and expand the node into a sub-graph 1004 by parsing the expression to determine if it references other expressions 1006 and fitting the expression sub-graph into the overall graph 1008.

Next the counterpointing system 208 may determine community affiliations for the expression 1010 by clustering publishers and actors in the system into communities 1012 and based on the clustering, determining a set of communities 1014. The counterpointing system 208 may then calculate the community's common perspectives and the sentiments contained in them 1016, assign community affiliation to the expression by comparing each of the actors or authors perspectives to the common community sentiments 1018, and calculate affiliation between pairs of communities 1020. Particular ones of these actions are described in more detail below.

The counterpointing system 208 first creates a node in the graph to represent the expression and the information available at that time. Initially this node is disconnected from the overall graph. The next step involves expanding the node into a sub-graph. Depending upon how the expression entered the system (e.g. user action, previous automated processing), some of this information may already be known. However, it may require extraction of information from the expression and its metadata, such as:
Topic(s).
Author(s) or publisher.
Actor (i.e. user performing social action with expression).

Additionally, the expression is parsed to determine if it references other expressions. The counterpointing system 208 may primarily rely upon hyperlinks for these external references, though it may also consider unlinked pieces of content that seem significant (e.g. block quotes). In practice this step may occur concurrently with intrinsic (content) analysis but is delineated separately here for clarity.

The next step involves fitting the expression graph fragment into the overall graph. This may occur by making any of the following connections:
Topic(s).
Other referenced expressions.
Author(s) or publisher.
Actor (i.e. user).

Initially the overall graph is sparsely populated with few connections among sub-graphs. This is intentional given the system's “limited knowledge” approach. For any potential connections that do not have existing nodes (e.g. referenced expressions), the system creates a placeholder node and that is then queued for full analysis. This helps to better prioritize analysis resources (e.g. boosting more heavily referenced nodes; ignoring seemingly dead ends) in keeping with the “limited knowledge” approach.

Using the results of intrinsic and extrinsic analysis, the counterpointing system 208 determines community affiliations for the expression. There are two related processes: community definition and affiliation assignment.

Community definition involves clustering publishers and actors in the system into communities. This is done by stepping through the knowledge graph to find:
Actors with shared perspectives (i.e. multiple expressions with similar sentiments on topics).
Publications with shared actors (both common authors and people with similar sentiments about expressions from the publications).
Publications with shared perspectives.

Based on this clustering the system algorithmically determines a set of communities. It then calculates the community's common perspectives and the sentiments contained in them. The number and definition of communities may change when this process is repeated over an expanded data set.

Affiliation assignment involves determining how strongly a community reflects an actor, publisher or expression. This is accomplished by comparing each of these entities' perspectives to the common community sentiments calculated earlier. This results in a score of both that indicates both the strength and direction of affiliation (e.g. positive or negative). The system also calculates affiliation between pairs of communities to determine which are “friends”, “foes” and “outsiders”.

The counterpointing system 208 determines a set of candidate expressions for eventual display to a user. Using information it has about the user (i.e. community affinities and content consumption history) and the current context (e.g. a particular expression), the system determines an entry point for the user into the knowledge map landscape. A set of communities are determined for the user and from these, expressions are evaluated for relevance and filtered out for display.

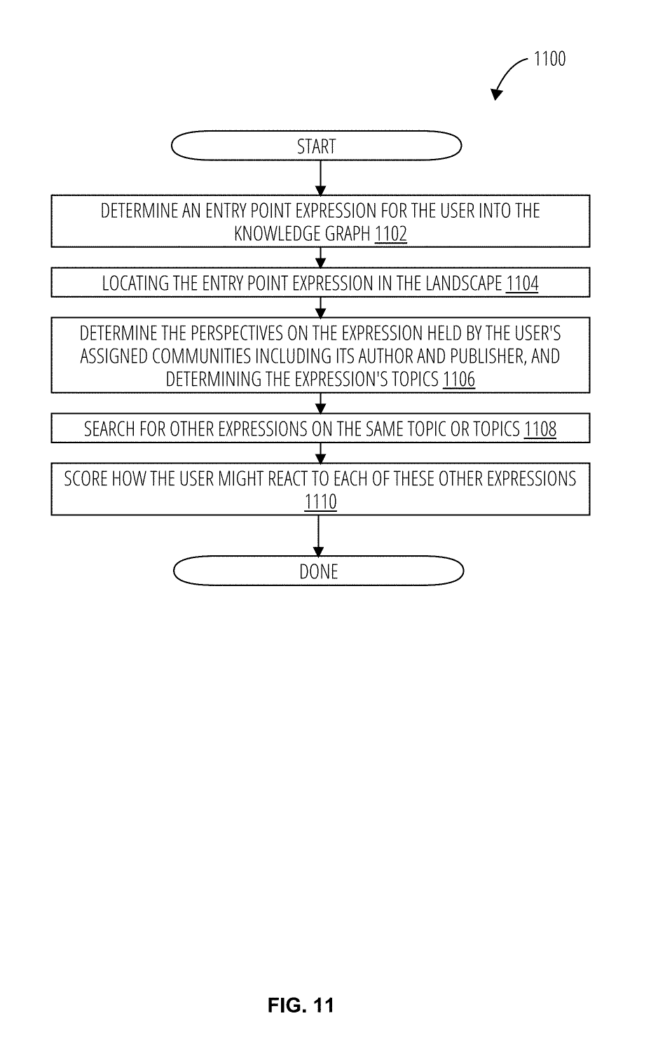

FIG. 11 illustrates aspects of an embodiment of an expression selection process for a user 1100. The counterpointing system 208 may determine an entry point expression for the user into the knowledge graph 1102 and locating the entry point expression in the landscape 1104. The counterpointing system 208 may then determine the perspectives on the expression held by the user's assigned communities including its author and publisher, and determining the expression's topics 1106, search for other expressions on the same topic or topics 1108 and score how the user might react to each of these other expressions 1110.

To perform these tasks the counterpointing system 208 may utilize the following inputs:
The user's history of content consumption (both during this session and overall).
Its own history of expressions presented to the user (including user response to them).
The number of available slots a display surface has (i.e. it aims for a cohesive set of expressions).
Analysis of expressions viewed or created by communities affiliated with the user
The user's estimated location on “the Golden Slope” (i.e. openness to countering perspectives, see FIG. 3).

If populating an injected widget, the counterpointing system 208 also inputs:
The expression, author and/or publisher the user is currently viewing.
Any actions the user may have taken on the expression (e.g. sharing, commenting or liking).
If the user has previously viewed this expression, expressions that reference it or expressions that are referenced by it.

The counterpointing system 208 balances the following priorities:
Relating to expressions the user has viewed and interacted with.
Exposing the user to new sources of and types of expressions.
Acclimating the user to new viewpoints.
Encouraging/challenging the user to move up the Golden Slope.
Comforting the user with familiar feeling expressions and viewpoints.
Delighting the user with unexpected but pertinent expressions.

For every topic there are multiple perspectives with multiple expressions. When providing expressions in response to an expression that the user is currently viewing, the system first locates that expression in the landscape.

The counterpointing system 208 may analyze the expression if it has not done so already. In that event, counterpointing system 208 proceeds as if is attempting to populate a more general set of expressions. It then determines the perspectives held by the user's communities on the current expression (including its author and publisher) and its topics.

The simplest case is if communities strongly agree or disagree with the current expression—which the system assumes is the default (i.e. people tend to consume content that agrees with their existing perspectives or they occasionally “hate watch” content to criticize it). Expressions with primarily ambivalent or mixed reactions may be more challenging to produce a high confidence set of candidate expressions. In the worst case, the system may supplement the results with those from the analysis of a similar expression.

The counterpointing system 208 then searches for other expressions on the same topic(s). This likely generates a large set. From this set it excludes expressions that are very similar to the current expression. It does this based both on community response to them (actual or estimated—as determined by extrinsic analysis) and the content of the expressions themselves (as determined by intrinsic analysis). The remaining set of expressions represent different perspectives on the same topic.

The counterpointing system 208 scores how the user might react to each new expression. It does this by evaluating the expression along the following dimensions (true equals positive score and there are no negative scores).
If communities with positive affinity have an inverse response (e.g. “I like the current expression and these people—and they disliked this other expression”).
If communities with negative affinity have a similar response (e.g. “I like the current expression and dislike these people—yet they liked this other expression”).
If communities with no affinity have a similar response, regardless of direction (e.g. “I have no opinion about these people but we both have strong opinions about both the current expression and this other expression”)
If regardless of community the expression has significantly different semantics or construction pattern than the current expression (e.g. “This is a novel expression”)
If the expression has a similar complexity level (either vocabulary or reading level)
Conversely, if the expression has vastly different complexity level

Sometimes a specific expression is not available as input to the counterpointing system 208. This may be either because an expression has not yet been analyzed or the system is being used in a more general context (e.g. a recap email). In this case the counterpointing system 208 generates a more general set of expressions based on the user's history. This might involve selecting expressions that:
Scored highly on previous queries that the user has yet to view.
Relate to topics, domains, authors or publishers the user has recently viewed.
Are general expressions that are highly effective for moving the user up the Golden Slope (FIG. 3).

The counterpointing system 208 selects specific candidate expressions to populate user interfaces. The selection of candidate expressions takes into account the following:
Number of expressions that the UI can display.
Overall balance of expressions as a set.
Effectively moving the user up the Golden Slope given their current location on it.
Keeping the user engaged with the counterpointing system 208 overall.

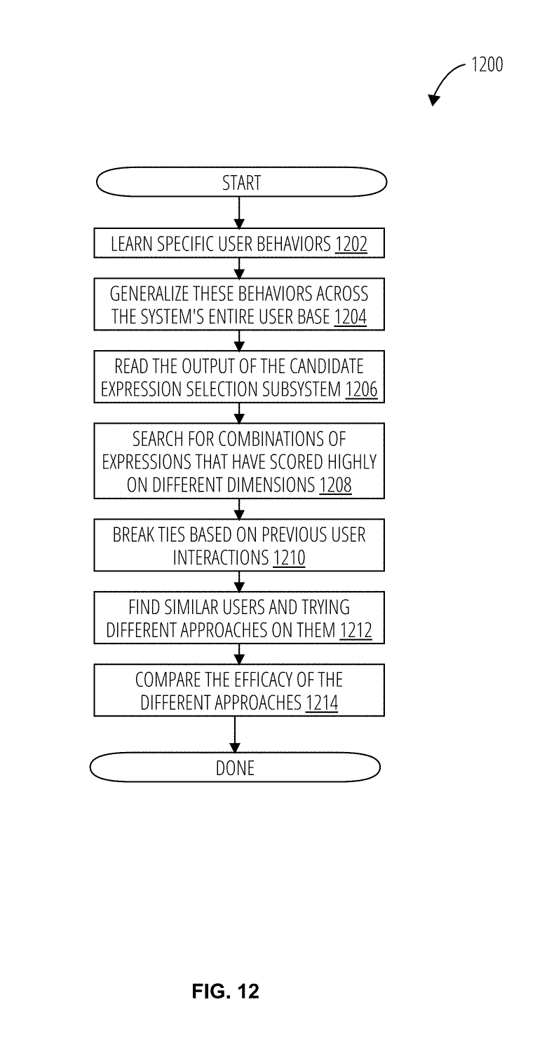

FIG. 12 illustrates aspects of a machine learning process 1200 to select expressions for display and to adapt in the process, according to one embodiment. The counterpointing system 208 may learn specific user behaviors 1202 and generalize these behaviors across the system's entire user base 1204. The counterpointing system 208 may read the output of the candidate expression selection subsystem 1206, search for combinations of expressions that have scored highly on different dimensions 1208, and break ties based on previous user interactions 1210. The counterpointing system 208 may find similar users and trying different approaches on them 1212 and compare the efficacy of the different approaches 1214. Particular ones of these actions are described in more detail below.

The counterpointing system 208 integrates a feedback loop to learn specific user behaviors and generalize these behaviors across the system's entire user base. Based on the results of the candidate expression selection, the counterpointing system 208 searches for combinations of expressions that have scored highly on different dimensions. There are several factors it attempts to optimize against:
Expressions with the highest scores in a single dimension.
Expressions with the highest combined scores across dimensions.
Diversity of communities represented (regardless of scores).
Diversity of expression semantics and construction patterns.
Expressions that the user has not seen before.
Expressions that are generally effective in moving similar users up the Golden Slope.

Because multiple combinations of expressions may solve these constraints, the counterpointing system 208 learns to break ties based on previous user interactions. There are several signals the counterpointing system 208 uses to optimize its choices while selecting combinations of expressions to show.
Immediate feedback (is the user ignoring or engaging with the expressions being presented?)
Aggregate long-term user behavior (in general what causes users to engage?)
Explicit feedback (“I don't like this”).

A critical element of this loop is determining the user's location on the Golden Slope. This is done through a combination of explicit user feedback (see “Targeted Surveys”) along with analysis of user behavior (see “Measurement”).

One way the counterpointing system 208 learns is by finding similar users (i.e. same position on the Golden Slope and/or same communities) and trying different approaches on them to compare efficacy. In addition to automated feedback, the system uses multiple strategies to select combinations of expressions. Initially these strategies are hard-coded into the system logic, but eventually new ones may be generated by the learning feedback loop. Below are several example strategies.

Handholding

Users may need to become accustomed to interacting with the system before being able to absorb new perspectives. In this case it may make sense to provide the user with expressions similar to those they like so that they start to interact with the system.

Balanced Meals

Users may prefer a certain combinations of expression types, community affiliations, construction patterns and/or sentiment ranges (e.g. a strongly different sentiment from another community, a mildly different sentiment from an affiliated community and a similar construction from an unknown community). The system may generate several sets of guidelines for the user interface generator 800 to use as reference when selecting combinations.

Blind Taste Tests

Another way the counterpointing system 208 may help users become open to new perspectives is by temporarily concealing the author or publisher of an expression. If the user is early on the Golden Slope and the expression is from an author or publisher with a negative community affinity for the user, the user may reflexively reject the expression (i.e. judging a book by its cover). The user interface generator 800 may therefore present the content of the expression before revealing who created it.

Shock & Awe

Conversely users may start to ignore expressions that are presented to them. In this case it may make sense for the counterpointing system 208 to offer expressions that are radically different with questionable efficacy to spur engagement.

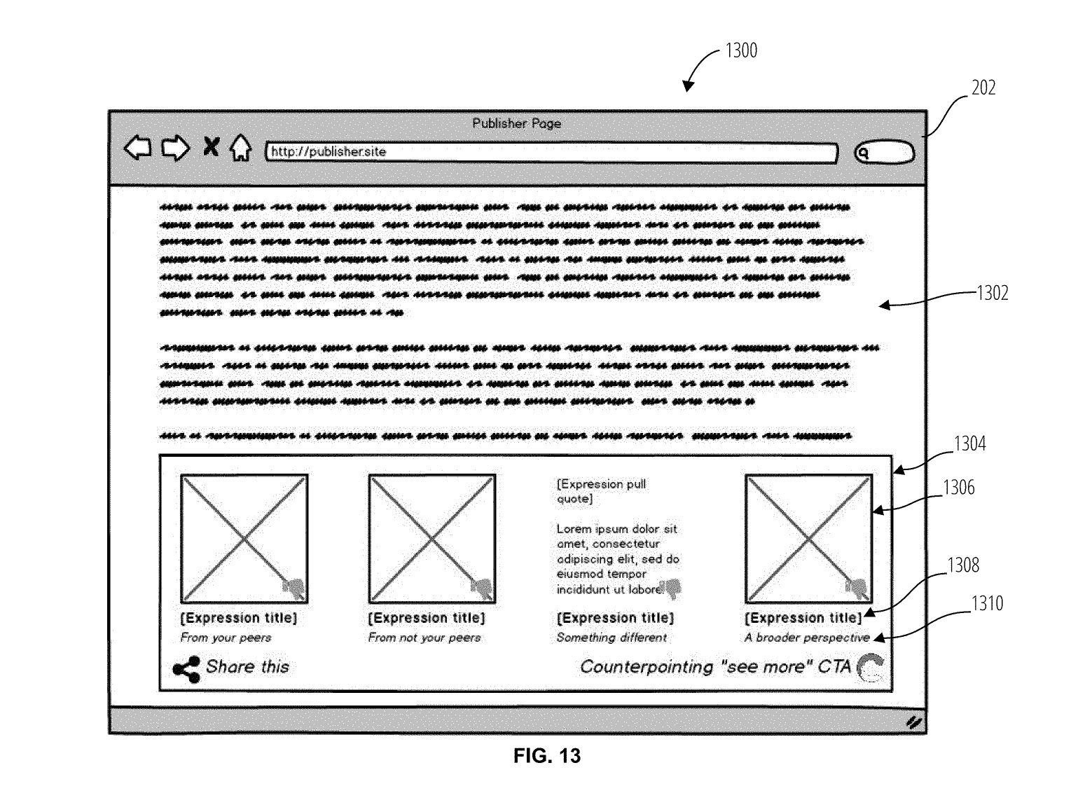

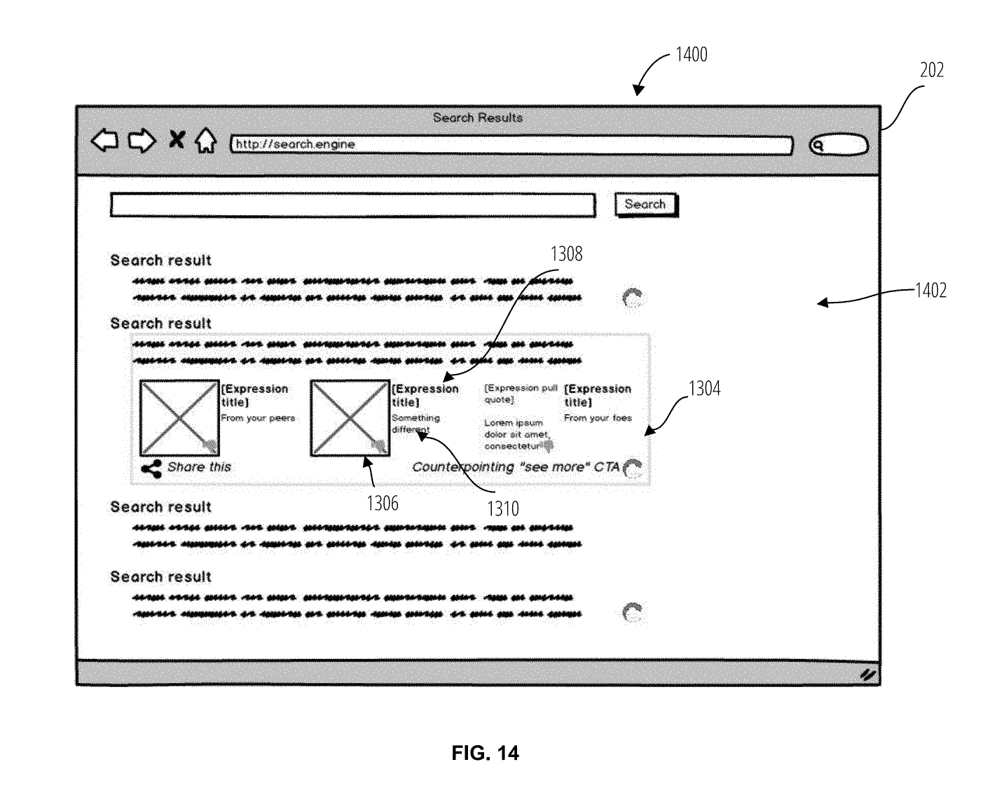

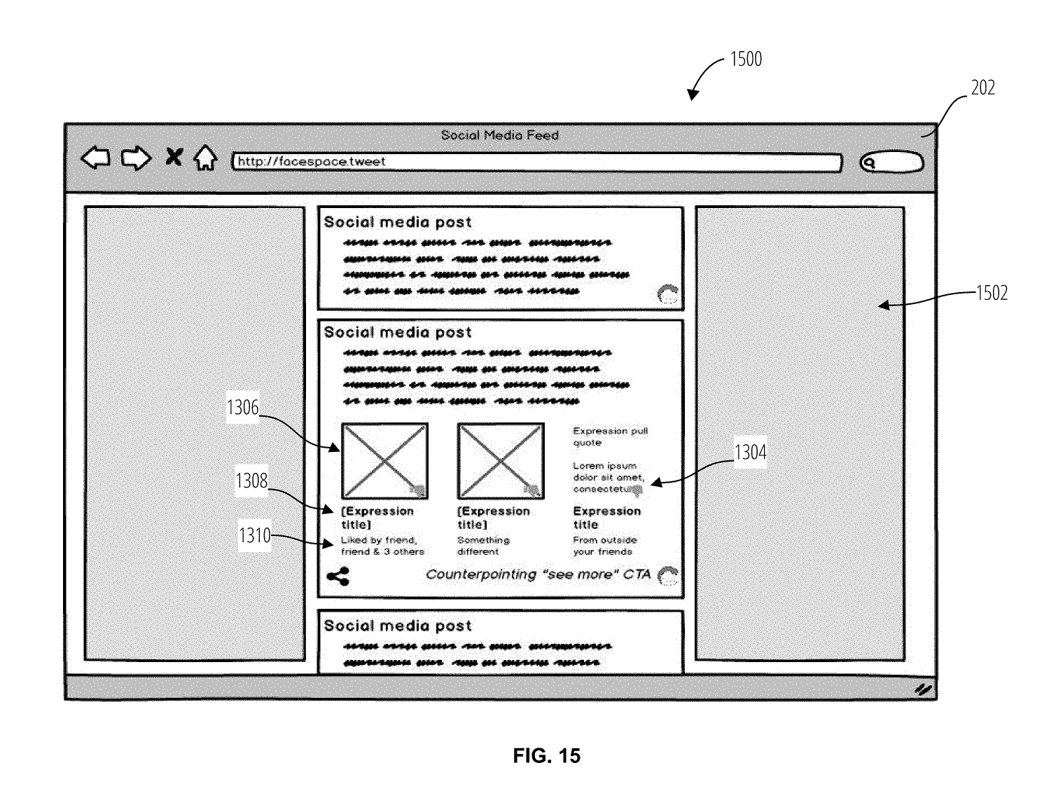

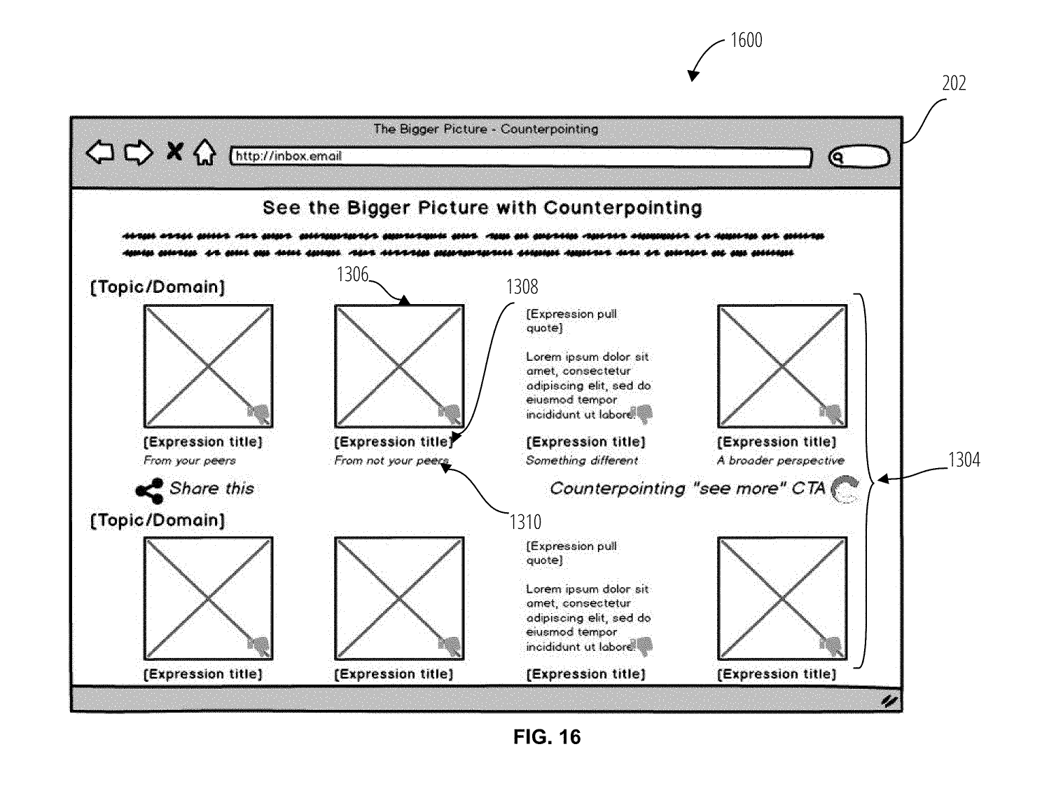

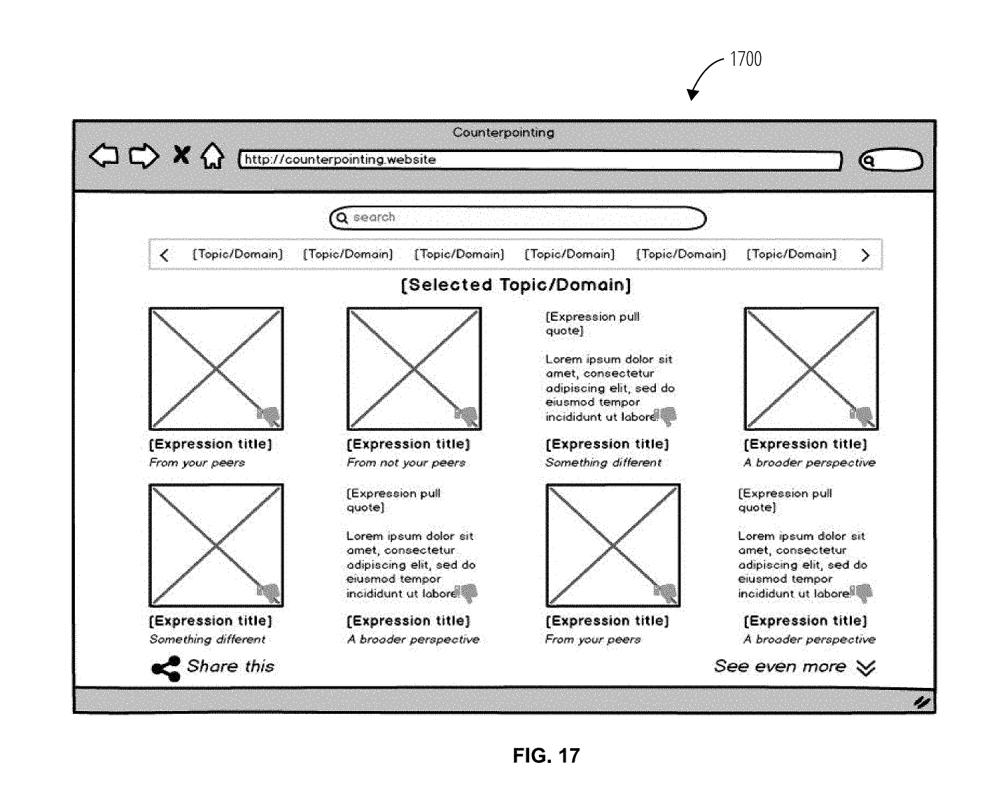

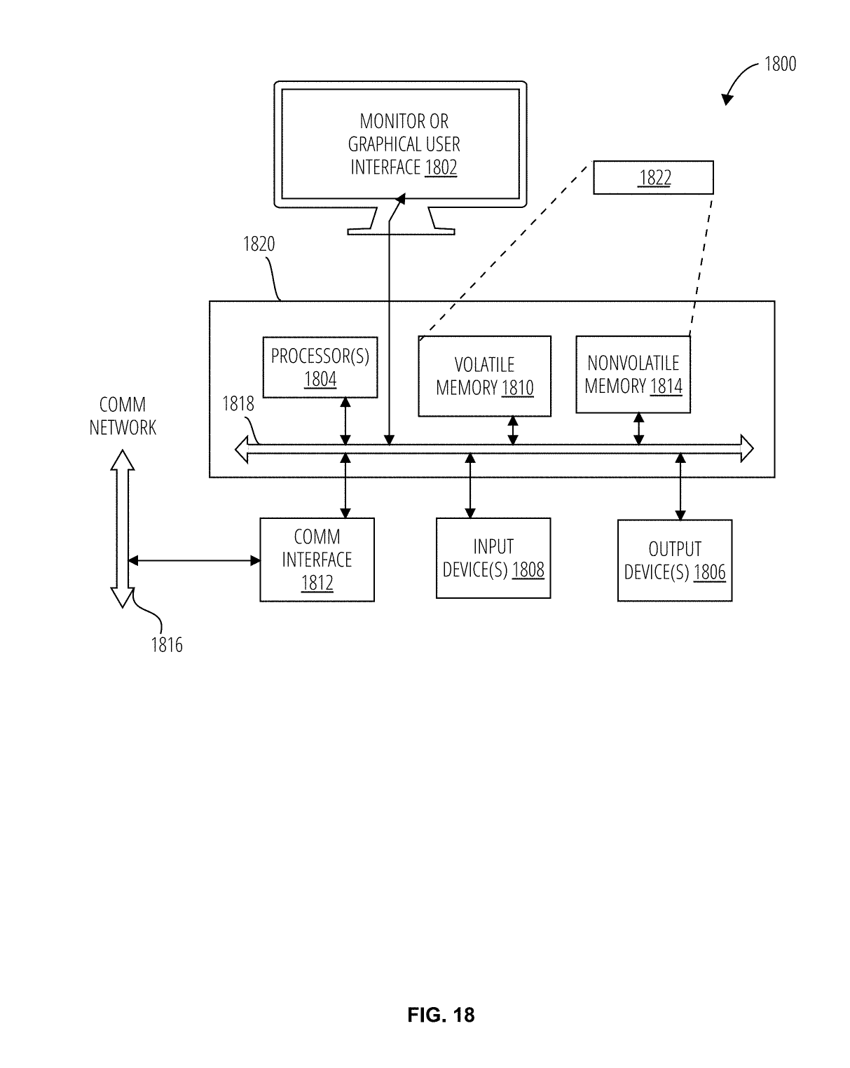

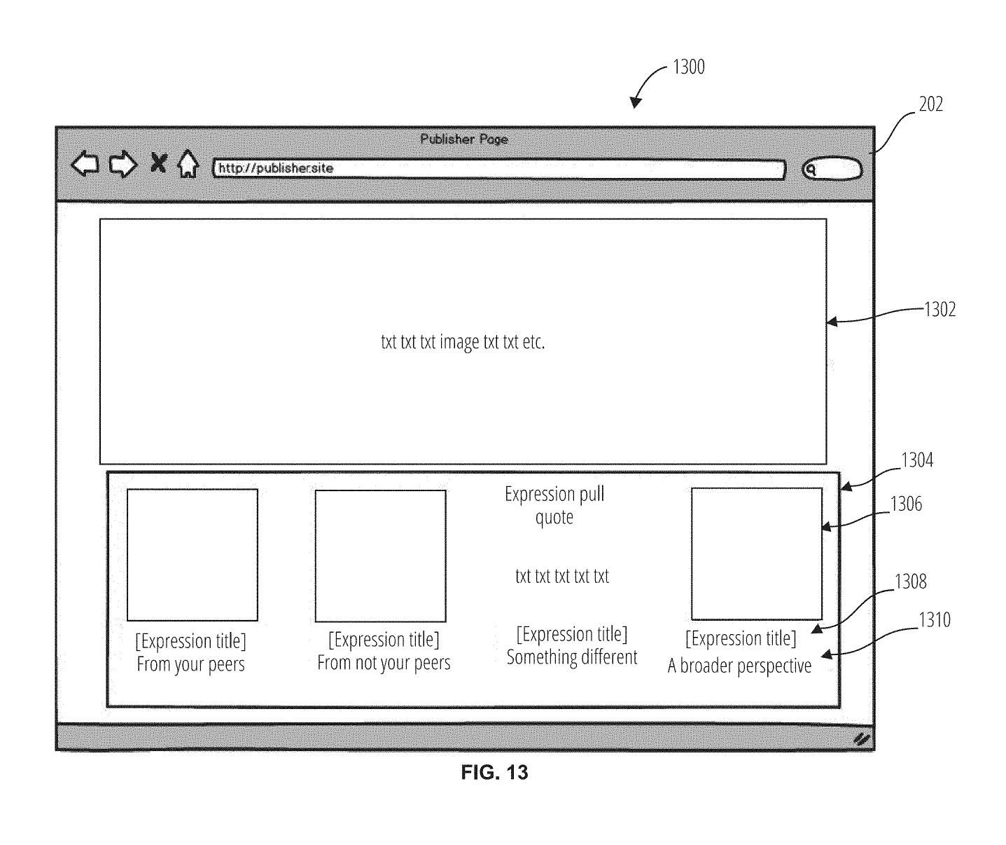

FIG. 13 illustrates an embodiment of a generated user interface 1300 for a content web page 1302, comprising a widget 1304 inserted into the web page 1302 using the feedback mechanisms of the counterpointing system 208. The widget 1304 is formed as a grid of at least one thumbnail 1306 and corresponding headline 1308 (e.g. 3×2 or 4×1) operable to link (drive the web browser 202) to other expressions. The other expressions will often be on different web sites. The generated user interface 1300 may comprise, for each thumbnail 1306, a label 1310 that contextualize why the expression is being presented (e.g. “A broader view”, “A countering perspective”).

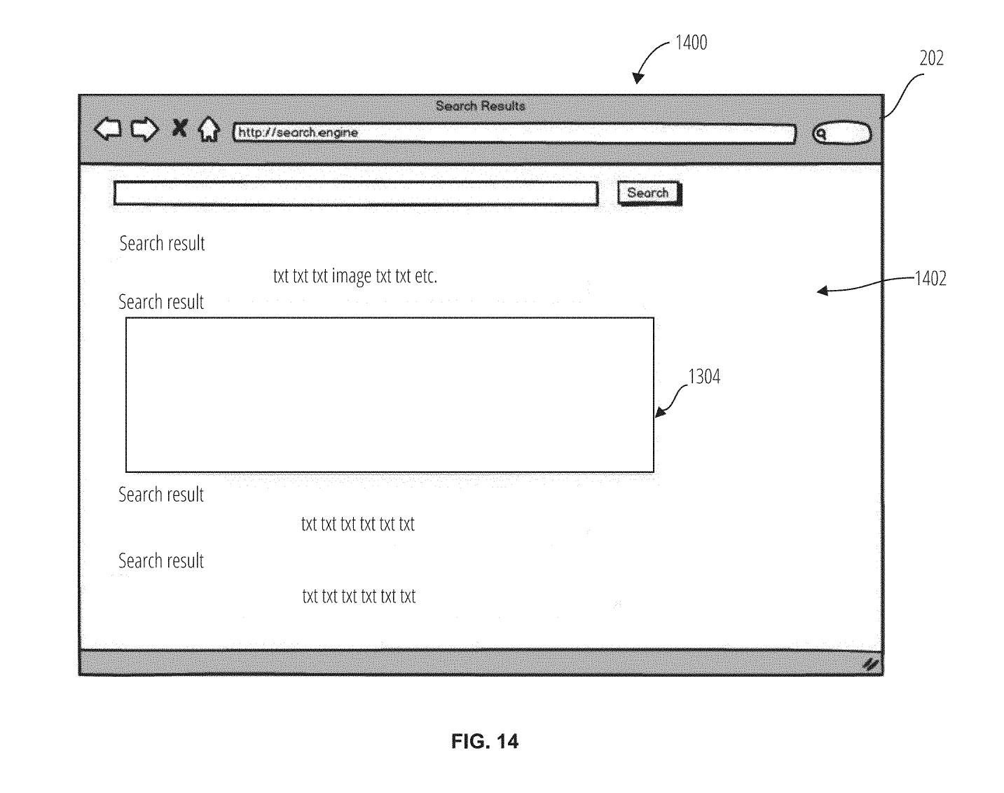

FIG. 14 shows a generated user interface 1400 for search results 1402, having similar features as the generated user interface 1300 for a content web page. The widget 1304 is inserted into the search results 1402.

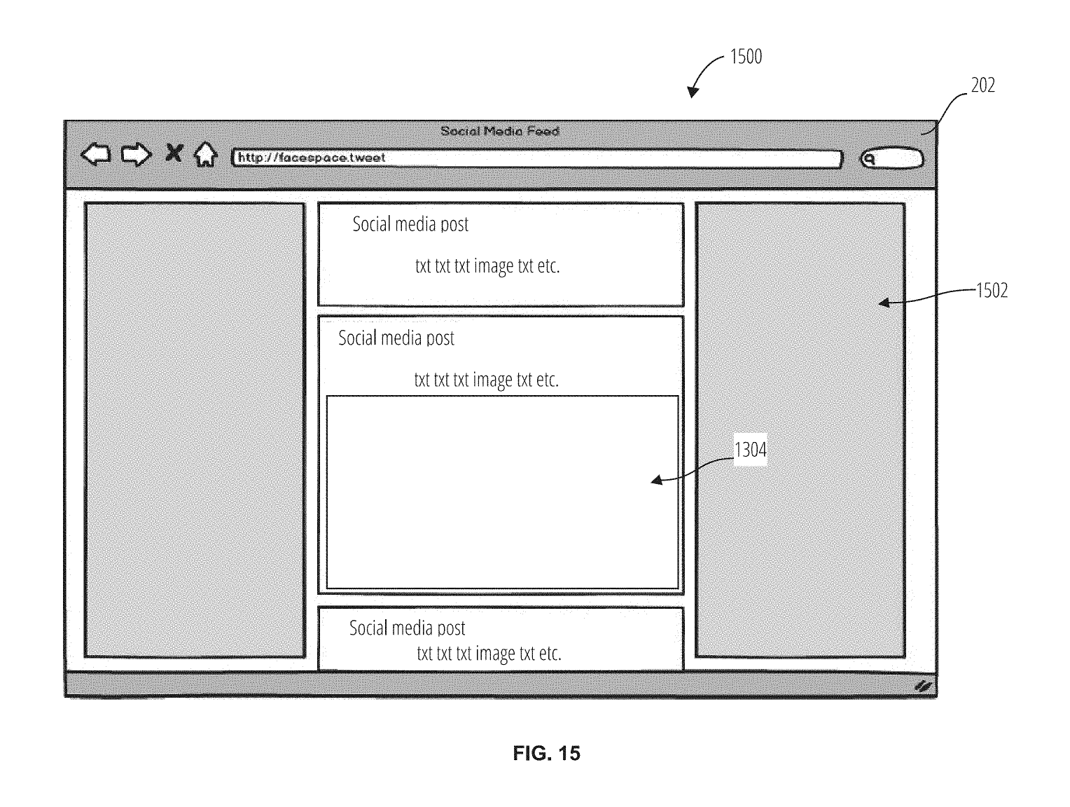

FIG. 15 shows a generated user interface 1500 for a social media feed 1502, having similar features as the other embodiments. The widget 1304 is inserted as a post or as part of a post in the social media feed 1502.

FIGS. 13-15 illustrate how the extension module in the web browser operates to display web content from a plurality of content sources and insert widgets in a manner particular to the content source from which the web content originates. The extension module widget handler is responsive to the content source adaptors to selectively insert the widgets into the web content displayed by the web browser. For example widgets are inserted differently for web pages vs social media feeds vs search results. The widgets are inserted differently in the sense of where they are inserted and in what capacity (e.g., as a web page control vs a supplement to a social media entry vs as a search result). The widget handler is adapted to insert the widgets in a manner particular to a particular content source of the content sources that provided the web content, as influenced by a corresponding one of the content source adaptors. A feedback loop operates between the extension module and the storage system. The feedback loop includes a similar-but-different (SBD) correlator coupled to receive inputs derived from the web content from the extension module and inputs from the storage system, an expression analyzer coupled to provide inputs to the SBD correlator, the expression analyzer operating on a knowledge graph generated from the content sources, and a machine learning module coupled as both an input and output of the SBD correlator. The SBD correlator generates links to alternate web content for inclusion in the widgets.

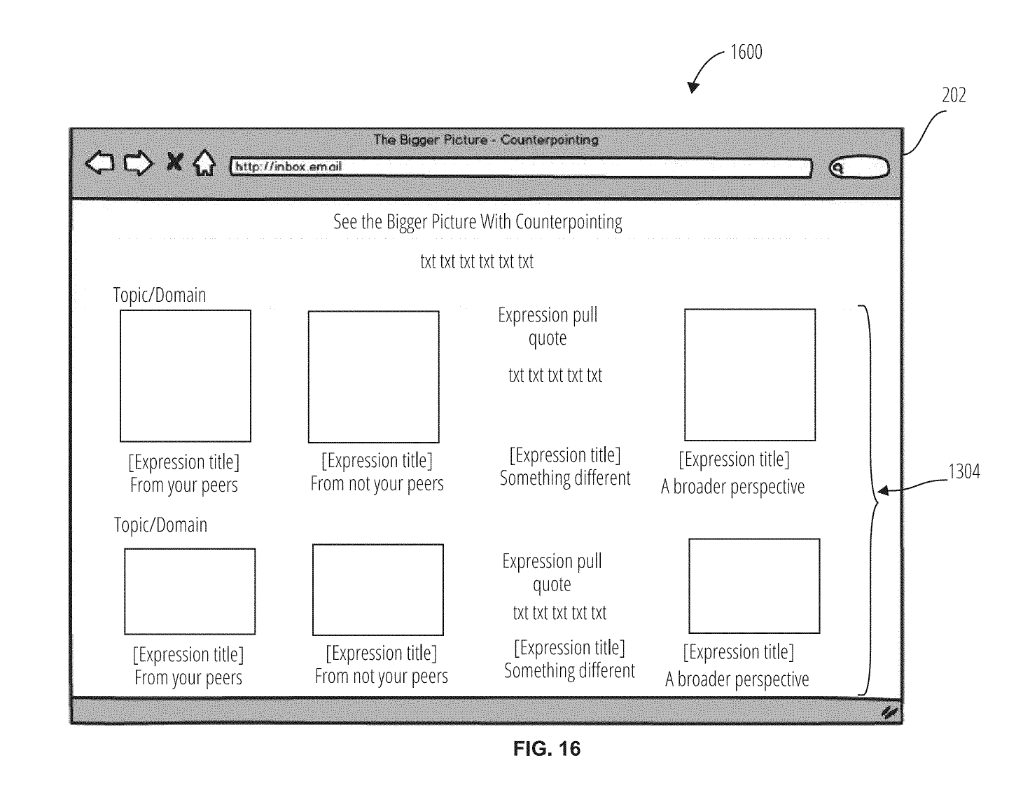

FIG. 16 illustrates an embodiment of a generated user interface 1600 in email that may be created by the counterpointing system 208 to recap perspectives a user may have missed. The recap is based on analysis of the user's content consumption and survey responses. Given the limitations of email, this interface may be generated when the email is generated and remains static regardless of subsequent user actions (e.g. viewing additional expressions).

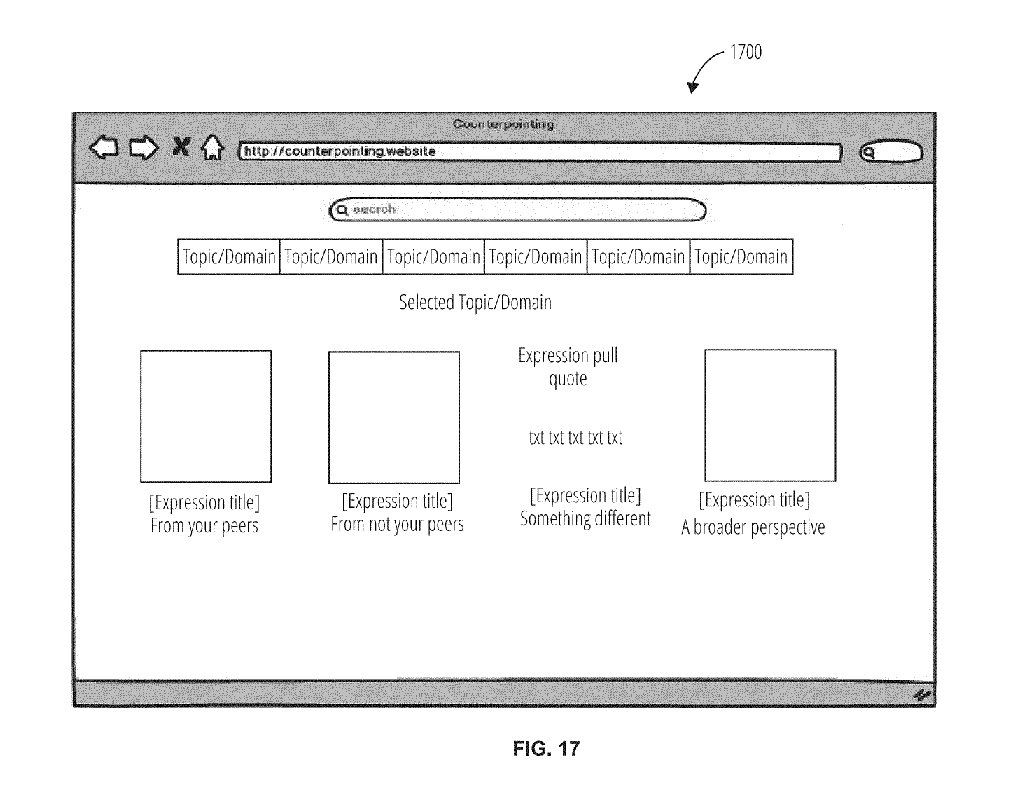

FIG. 17 illustrates an embodiment of a counterpoint web site 1700 designed to log in users and present a version of the “Bigger Picture” (although unlike the generated user interface 1600 for email, with continuously updated content). The web site 1700 enables users to search and browse topics.

FIG. 18 is an example block diagram of a computing device 1800 that may incorporate embodiments of the present invention. FIG. 18 is merely illustrative of a machine system to carry out aspects of the technical processes described herein, and does not limit the scope of the claims. One of ordinary skill in the art would recognize other variations, modifications, and alternatives. In one embodiment, the computing device 1800 typically includes a monitor or graphical user interface 1802, a data processing system 1820, a communication network interface 1812, input device(s) 1808, output device(s) 1806, and the like. The computing device 1800 could for example implement aspects of a client device 106 or a server 104.

As depicted in FIG. 18, the data processing system 1820 may include one or more processor(s) 1804 that communicate with a number of peripheral devices via a bus subsystem 1818. These peripheral devices may include input device(s) 1808, output device(s) 1806, communication network interface 1812, and a storage subsystem, such as a volatile memory 1810 and a nonvolatile memory 1814.

The volatile memory 1810 and/or the nonvolatile memory 1814 may store computer-executable instructions and thus forming logic 1822 that when applied to and executed by the processor(s) 1804 implement embodiments of the processes disclosed herein.

The input device(s) 1808 include devices and mechanisms for inputting information to the data processing system 1820. These may include a keyboard, a keypad, a touch screen incorporated into the monitor or graphical user interface 1802, audio input devices such as voice recognition systems, microphones, and other types of input devices. In various embodiments, the input device(s) 1808 may be embodied as a computer mouse, a trackball, a track pad, a joystick, wireless remote, drawing tablet, voice command system, eye tracking system, and the like. The input device(s) 1808 typically allow a user to select objects, icons, control areas, text and the like that appear on the monitor or graphical user interface 1802 via a command such as a click of a button or the like.

The output device(s) 1806 include devices and mechanisms for outputting information from the data processing system 1820. These may include the monitor or graphical user interface 1802, speakers, printers, infrared LEDs, and so on as well understood in the art.

The communication network interface 1812 provides an interface to communication networks (e.g., communication network 1816) and devices external to the data processing system 1820. The communication network interface 1812 may serve as an interface for receiving data from and transmitting data to other systems. Embodiments of the communication network interface 1812 may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface 1812 may be coupled to the communication network 1816 via an antenna, a cable, or the like. In some embodiments, the communication network interface 1812 may be physically integrated on a circuit board of the data processing system 1820, or in some cases may be implemented in software or firmware, such as “soft modems”, or the like.

The computing device 1800 may include logic that enables communications over a network using protocols such as HTTP, TCP/IP, RTP/RTSP, IPX, UDP and the like.

The volatile memory 1810 and the nonvolatile memory 1814 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1810 and the nonvolatile memory 1814 may be configured to store the basic programming and data constructs that provide the functionality of the disclosed processes and other embodiments thereof that fall within the scope of the present invention.

Logic 1822 that implements embodiments of the present invention may be stored in the volatile memory 1810 and/or the nonvolatile memory 1814. Said logic 1822 may be read from the volatile memory 1810 and/or nonvolatile memory 1814 and executed by the processor(s) 1804. The volatile memory 1810 and the nonvolatile memory 1814 may also provide a repository for storing data used by the logic 1822.

The volatile memory 1810 and the nonvolatile memory 1814 may include a number of memories including a main random-access memory (RAM) for storage of instructions and data during program execution and a read only memory (ROM) in which read-only non-transitory instructions are stored. The volatile memory 1810 and the nonvolatile memory 1814 may include a file storage subsystem providing persistent (non-volatile) storage for program and data files. The volatile memory 1810 and the nonvolatile memory 1814 may include removable storage systems, such as removable flash memory.

The bus subsystem 1818 provides a mechanism for enabling the various components and subsystems of data processing system 1820 communicate with each other as intended. Although the communication network interface 1812 is depicted schematically as a single bus, some embodiments of the bus subsystem 1818 may utilize multiple distinct busses.

It will be readily apparent to one of ordinary skill in the art that the computing device 1800 may be a device such as a smartphone, a desktop computer, a laptop computer, a rack-mounted computer system, a computer server, or a tablet computer device. As commonly known in the art, the computing device 1800 may be implemented as a collection of multiple networked computing devices. Further, the computing device 1800 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

What is claimed is:

1. A system comprising:
an extension module in a web browser to display web content from a plurality of content sources;
the extension module comprising a widget handler responsive to a plurality of content source adaptors to selectively insert widgets into the web content displayed by the web browser;
the widget handler adapted to insert the widgets in a manner particular to a particular content source of the content sources that provided the web content, as influenced by a corresponding one of the content source adaptors;
a feedback loop between the extension module and a storage system, the feedback loop comprising:
a similar-but-different (SBD) correlator coupled to receive inputs derived from the web content from the extension module and inputs from the storage system;
an expression analyzer coupled to provide inputs to the SBD correlator, the expression analyzer operating on a knowledge graph generated from the content sources;
a machine learning module coupled as both an input and output of the SBD correlator; and
the SBD correlator generating links to alternate web content for inclusion in the widgets.
